(19) United States
(12) Patent Application Publication
(10) Pub. No.: US 2021/0286581 A1
(43) Pub. Date: Sep. 16, 2021

(54) COMMUNICATION SYSTEM, COMMUNICATION TERMINAL, AND DISPLAY METHOD

(71) Applicants: TAKASHI HASEGAWA, KANAGAWA (JP); KATSUYUKI TODA, KANAGAWA (JP); TAKESHI HORIUCHI, TOKYO (JP)

(72) Inventors: TAKASHI HASEGAWA, KANAGAWA (JP); KATSUYUKI TODA, KANAGAWA (JP); TAKESHI HORIUCHI, TOKYO (JP)

(73) Assignee: Ricoh Company, Ltd., Tokyo (JP)

(21) Appl. No.: 17/191,920

(22) Filed: Mar. 4, 2021

(30) Foreign Application Priority Data
Mar. 13, 2020 (JP) 2020-044210

(51) Int. Cl. G06F 3/14; G06F 3/0482; G06F 3/0484; G06F 3/0488

(52) U.S. Cl. CPC G06F 3/1454; G06F 3/04883; G06F 3/0484; G06F 3/0482

(57) ABSTRACT

A communication system includes a first communication terminal and a second communication terminal. The first communication terminal includes first circuitry to display, on a first display, a first screen including information. The second communication terminal includes second circuitry to display, on a second display, a second screen including the information, which is same as the first screen. The first screen and the second screen are different from each other in accepting operations performed with respect to the displayed information.

### CROSS-REFERENCE TO RELATED APPLICATIONS

This patent application is based on and claims priority pursuant to 35 U.S.C. § 119(a) to Japanese Patent Application No. 2020-044210, filed on Mar. 13, 2020, in the Japan Patent Office, the entire disclosure of which is hereby incorporated by reference herein.

### BACKGROUND

### Technical Field

Embodiments of the present disclosure relate to a communication system, a communication terminal, and a display method.

### Related Art

In recent years, a remote concierge service is provided from the viewpoint of streamlining store operations and increasing efficiency. With the remote concierge service, for example, even when a customer in a store has to wait for a support from a staff of the store because the staff in the store is serving other customers, the customer uses a first terminal (hereinafter referred to as a store terminal) to accesses, via the Internet or the like, a second communication terminal (hereinafter referred to as an explainer terminal) of an explainer (concierge) in a remote service center, who has a specialized skills. The customer communicates with the explainer through a video call, thereby receiving a customer service.

Further, recently, in addition to manned stores in which one or more staff members who serve customers are present, unmanned stores are operated in which no staff is present.

The store terminal is provided also in such unmanned stores, and the customer visits an unmanned store and uses the store terminal to communicate with the explainer in a service center through a video call, thereby receiving a customer service.

The store terminal and the explainer terminal display the same materials (documents), etc., and the customer and the explainer have a conversation while looking at the materials. In addition, these terminals allow the customer and the explainer to write strokes on the screens displaying the materials by hand, resulting in improving the efficiency of the communication. With respect to such a communication system, a technique has been devised for restricting performing other operations while an operation that is drawing a stroke is being performed.

### SUMMARY

An exemplary embodiment of the present disclosure includes a communication system including a first communication terminal and a second communication terminal. The first communication terminal includes first circuitry to display, on a first display, a first screen including information. The second communication terminal includes second circuitry to display, on a second display, a second screen including the information, which is same as the first screen. The first screen and the second screen are different from each other in accepting operations performed with respect to the displayed information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1A and FIG. 1B are diagrams respectively illustrating a screen displayed by a store terminal and a screen displayed by an explainer terminal, according to an embodiment of the present disclosure;

FIG. 2 is a schematic diagram illustrating an example of a configuration of a communication system, according to an embodiment of the present disclosure;

FIG. 3 is an illustration of a situation in which customers in stores and explainers in a service center are remotely performing a video call, according to an embodiment of the present disclosure;

FIG. 4 is a block diagram illustrating an example of a hardware configuration of each of a store terminal, an administrator terminal, an explainer terminal, a relay apparatus, a communication management apparatus, and a service information management apparatus of a communication system, according to an embodiment of the present disclosure;

FIG. 5 is a block diagram illustrating an example of a functional configuration of a communication system, according to an embodiment of the present disclosure;

FIG. 6 is a block diagram illustrating an example of a functional configuration of a communication system, according to an embodiment of the present disclosure;

FIG. 7A is a conceptual diagram illustrating an explainer management table, according to an embodiment of the present disclosure;

FIG. 7B is a conceptual diagram illustrating a skill group management table, according to an embodiment of the present disclosure;

FIG. 8A is a conceptual diagram illustrating an authentication management table, according to an embodiment of the present disclosure;

FIG. 8B is a conceptual diagram illustrating a terminal state management table, according to an embodiment of the present disclosure;

FIG. 9A is a conceptual diagram illustrating a destination list management table, according to an embodiment of the present disclosure;

FIG. 9B is a conceptual diagram illustrating a session management table, according to an embodiment of the present disclosure;

FIG. 9C is a conceptual diagram illustrating a communication information management table, according to an embodiment of the present disclosure;

FIG. 10A to FIG. 10C are conceptual diagrams illustrating stroke data management tables, according to an embodiment of the present disclosure;

FIG. 11A is a conceptual diagram illustrating a system update information management table, according to an embodiment of the present disclosure;

FIG. 11B is a conceptual diagram illustrating a company management table, according to an embodiment of the present disclosure;

FIG. 11C is a conceptual diagram illustrating a group (area) management table, according to an embodiment of the present disclosure;

FIG. 12A is a conceptual diagram illustrating a terminal management table, according to an embodiment of the present disclosure;

FIG. 12B is a conceptual diagram illustrating a skill management table, according to an embodiment of the present disclosure;

FIG. 13A is a conceptual diagram illustrating a login information management table, according to an embodiment of the present disclosure;

FIG. 13B is a conceptual diagram illustrating a subgroup management table, according to an embodiment of the present disclosure;

FIG. 13C is a conceptual diagram illustrating a user update information management table, according to an embodiment of the present disclosure;

FIG. 14 is a sequence diagram illustrating operation of registering service information, according to an embodiment of the present disclosure;

FIG. 15 is a diagram illustrating an example of a login screen displayed on the administrator terminal, according to an embodiment of the present disclosure;

FIG. 16 is a diagram illustrating an example of a store list screen displayed on the administrator terminal, according to an embodiment of the present disclosure;

FIG. 17 is a diagram illustrating an example of an explainer list screen displayed on the administrator terminal, according to an embodiment of the present disclosure;

FIG. 18 is a diagram illustrating an example of a group list screen displayed on the administrator terminal, according to an embodiment of the present disclosure;

FIG. 19 is a diagram illustrating an example of an explainer information edit screen displayed on the administrator terminal, according to an embodiment of the present disclosure;

FIG. 20 is a diagram illustrating an example of a group information edit screen displayed on the administrator terminal, according to an embodiment of the present disclosure;

FIG. 21 is a diagram illustrating an example of a store information edit screen displayed on the administrator terminal, according to an embodiment of the present disclosure;

FIG. 22 is a sequence diagram illustrating operation of preparing a video call by the store teuninal, specifically operation of acquiring service information, according to an embodiment of the present disclosure;

FIG. 23 is a sequence diagram illustrating operation of preparing a video call by the store terminal, specifically operation of acquiring an operating state of each terminal, according to an embodiment of the present disclosure;

FIG. 24 is a flowchart illustrating operation of preparing a video call by the store terminal, specifically operation of determining an operating state of an explainer terminal group for each skill, according to an embodiment of the present disclosure;

FIG. 25A to FIG. 25D are diagrams each illustrating a screen displayed on the store terminal, according to an embodiment of the present disclosure;

FIG. 26 is a sequence diagram illustrating operation of starting a video call, according to an embodiment of the present disclosure;

FIG. 27 is a sequence diagram illustrating detailed processes of controlling establishment of the session, according to an embodiment of the present disclosure;

FIG. 28 is a flowchart illustrating various types of processes of starting a call, according to an embodiment of the present disclosure;

FIG. 29A is sequence diagram illustrating an example of processing or operation performed by a communication system when a customer and an explainer bidirectionally write on a document, according to an embodiment of the present disclosure;

FIG. 29B is sequence diagram illustrating another example of processing or operation performed by a communication system when a customer and an explainer bidirectionally write on a document, according to an embodiment of the present disclosure;

FIG. 30 is a diagram illustrating an example of a writable window displayed by a store terminal and a writable window displayed by an explainer terminal, according to an embodiment of the present disclosure;

FIG. 31 is a sequence diagram illustrating an example of processing or operation in which an explainer terminal restricts operations performed with a store terminal, according to an embodiment of the present disclosure;

FIG. 32 is a conceptual diagram illustrating an example of the restriction setting table, according to an embodiment of the present disclosure;

FIG. 33 is a diagram illustrating another example of a writable window displayed by a store terminal and a writable window displayed by an explainer terminal, according to an embodiment of the present disclosure;

FIG. 34A to FIG. 34D are diagrams each illustrating an example of a writable window displayed in a case in which a restricted area to which writing of stroke data is not acceptable is specified, according to an embodiment of the present disclosure;

FIG. 35 is a sequence diagram illustrating an example of processing or operation in which an explainer assigns explainer authority to another explainer, according to an embodiment of the present disclosure; and

FIG. 36 is a diagram illustrating an example of writable windows each of which is displayed by an explainer terminal used by an explainer or another explainer, according to an embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, a description is given of a communication system and a method of displaying a screen performed by the communication system according to one or more embodiments with reference to the drawings.

Overview of Embodiment:

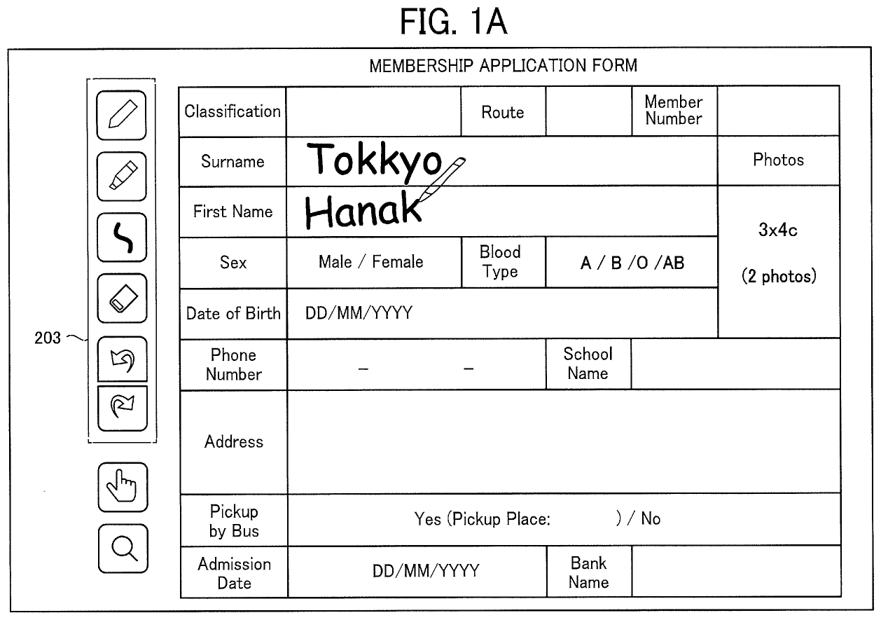

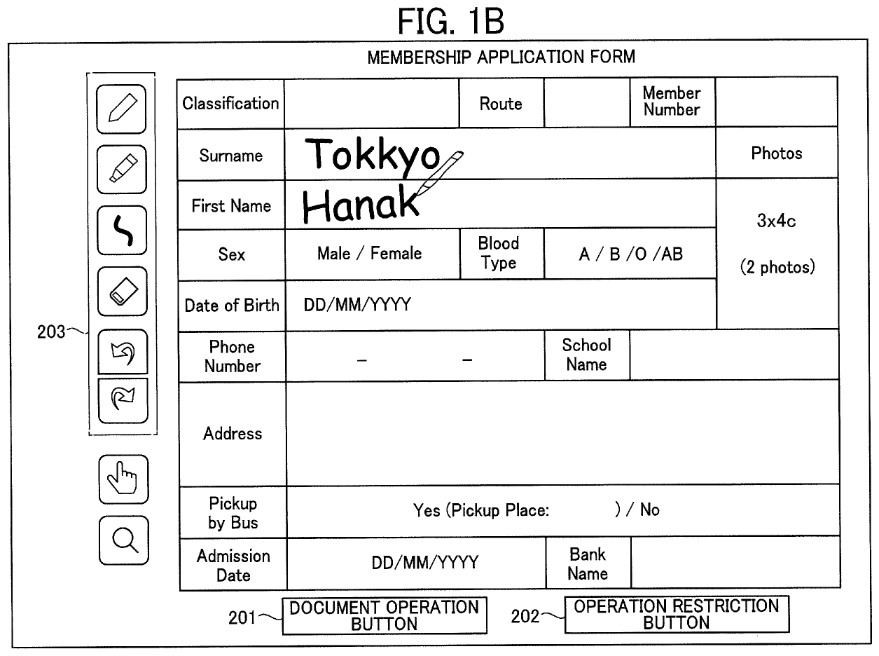

A description is given below of an overview of a configuration of a communication system according to an embodiment of the disclosure, with reference to FIG. 1A and FIG. 1B. FIG. 1A and FIG. 1B are diagrams illustrating examples of a screen displayed by a communication terminal of a store (hereinafter referred to as a store terminal) and another screen displayed by another communication terminal of an explainer (hereinafter referred to as an explainer terminal). The explainer is a person who explains about information displayed on the screens, and includes an assistant, a concierge, a staff, and the like. FIG. 1A and FIG. 1B are diagrams respectively illustrating the screen displayed by the store terminal and the screen displayed by the explainer terminal, according to the present embodiment. Each screen is a writable window, of which a detailed description is given later. Documents, or materials, are displayed on the writable window, and handwrite strokes are writable on the writable window by a customer or the explainer. The writable window is also subject to restrictions on customer operations.

Both the store terminal and the explainer tettninal display the same document, “MEMBERSHIP APPLICATION FORM”. Each of the store terminal and the explainer terminal has a touch panel, and handwritten strokes are writable on the document by each of the customer and the explainer of the store by using a pen or the like. The strokes handwritten by the customer of the store are displayed not only on the writable window of the store terminal but also on the writable window of the explainer terminal. In addition, the strokes handwritten by the explainer are displayed not only on the writable window of the explainer terminal but also on the writable window of the store terminal. That is, the stroke data is synchronized between those bases (sites). This allows the explainer to check handwritten inputs made by the customer in real time, and this allows the customer to enter necessary items by handwriting according to guidance of the explainer.

However, in a case of a store terminal that allows customers to perform operations for moving from a current page to another page, switching documents, and the like, a customer who is not familiar with how to use or to operate the store terminal may perform an unfavorable operation.

In view of the above-described case, in the present embodiment, the store terminal and the explainer terminal display screens in which one of screen displays buttons for accepting operations different from that displayed on the other screen, for example. In other words, the store terminal displays a screen with information that is same as the information displayed on a screen of the explainer terminal, according to an account type of the store terminal (own terminal), but has restriction on operations acceptable with respect to the information being displayed on the screen, which is different from the screen of the explainer terminal.

For example, in the example of FIG. 1A and FIG. 1B, the explainer terminal includes a document operation button 201 and an operation restriction button 202, but the store terminal does not. Accordingly, operations for adding a page, deleting a page, switching pages, switching documents and the like are performable by using the explainer terminal used by the explainer who is a user having the authority as an explainer. As a result, document operations such as page switching is not required to be performed by the store terminal, and most of the document operations are performed by the explainer alone.

Referring to FIG. 1A and FIG. 1B, the explainer terminal has the operation restriction button 202, but the store terminal does not. The operation restriction button 202 is a button for restricting operations performable by using the store terminal. This allows the explainer to set restriction on input operations performed by the customer so that the customer is unable to fill in or edit with respect to a page or an area of an application form set as a target of the restriction. This prevents unintentional input or editing performed by the customer.

As described above, in the communication system according to the present embodiment, the store terminal and the explainer terminal display different screens regarding the buttons for accepting user operations, and the acceptable user operations change depending on whether a terminal is the store terminal or the explainer terminal, accordingly.

Regarding Terms:

“Explainer” is defined as a person who explains details or meaning of a subject matter in an easy-to-understand manner. An explainer may be alternatively referred to as an operator, a concierge, a guide, an instructor, an advisor, an assistant, a staff, or the like.

“Customer” is defined as a person who purchases or may purchase a product or a service from an explainer. A customer may be a person who simply visits the store.

In the description of one or more embodiments, a first communication terminal is a communication terminal arranged in a store and operated by any customer, and a second communication terminal is a communication terminal arranged at a base (site) of each explainer. The first communication terminal may be an information processing device owned by the customer.

Due to changing of a screen displayed on the store terminal, acceptable operations with respect to information being displayed in common with the explainer terminal are different from that of the explainer terminal.

A series of operations in which a user presses an input device (means) against a display, moves the input device (means) continuously, and then releases the input device (means) from the display is referred to as a stroke operation or a stroke. “Stroke data” is information that is displayed on a display based on a trajectory of coordinates input by using the input device (means). Such stroke data may be interpolated appropriately. In the present embodiment, the “stroke” and the “stroke data” are not strictly distinguished from each other.

Overview of Configuration of Communication System:

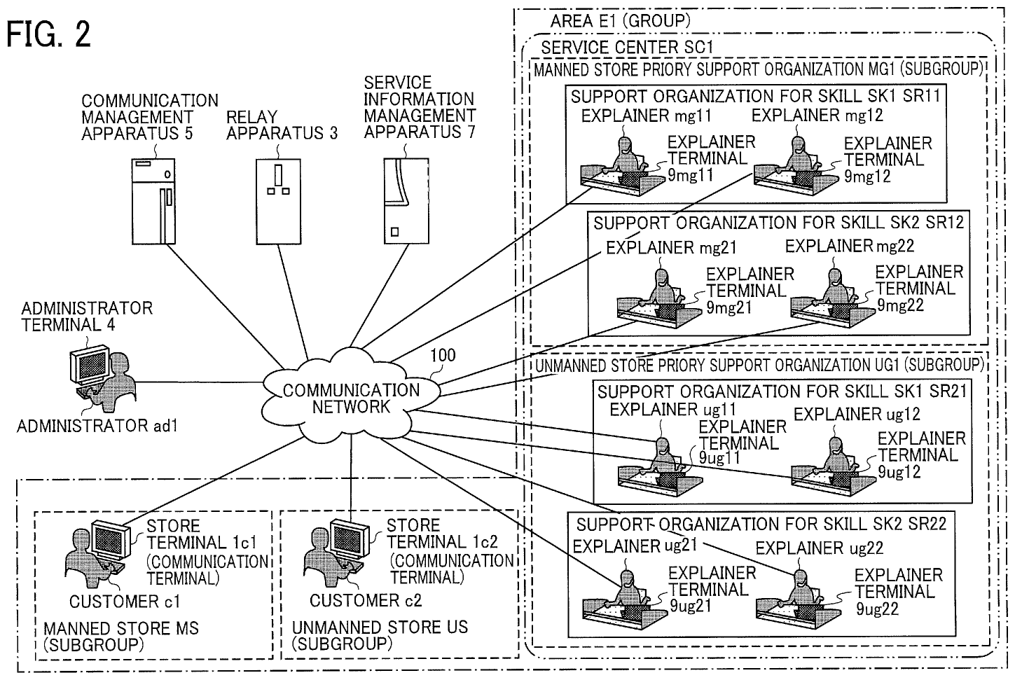

A description is now given of an overview of a configuration of a communication system 2 with reference to FIG. 2. FIG. 2 is a schematic diagram illustrating an overview of the communication system 2 according to the present embodiment of the disclosure. In the example of FIG. 2, customers, a travel agency that sells travel products to the customers, and a system provider that provides the travel agency with a system for performing remote concierge (remote customer service) are illustrated.

A travel agency operates manned stores, unmanned stores, and service centers in each of a plurality of areas such as Kanto district and Kansai district in Japan. FIG. 2 illustrates that the travel agency operates a manned store MS, an unmanned store US, and a service center SC1 in an area E1. The manned store MS is a store in which a staff who serves the customers is present. The unmanned store is a store in which no staff who serves the customers is present. Although one manned store MS and one unmanned store US are illustrated in FIG. 2, this is just an example. In another example, plural manned stores MS and plural unmanned stores can be provided.

In the manned store MS, a staff usually provides a guide about travel products to customers who visit the store. However, there is a case where no staff can provide a service to a newly visited customer because all staff members are serving other customers. In the unmanned store US, there is no staff who serves customers. In such cases, the customer uses a store terminal 1c1 in the manned store MS or a store terminal 1c2 in the unmanned store US to access an explainer terminal of an explainer in the service center SC1 via a communication network 100 such as the Internet, thereby receiving a remote customer service regarding travel products from the explainer.

The store terminal 1c1 and the store terminal 1c2 are each configured by a personal computer (PC). A plurality of store terminals may be provided in the manned store MS and the unmanned store US. In the following description, the plurality of store terminals such as the store terminal 1c1 and the store terminal 1c2 are collectively referred to as a “store terminal 1” or “store terminals 1” to simplify the description.

The service center SC1 includes a manned store priority support organization MG1 that preferentially receives a call start request for starting the remote customer service from the store terminal 1c1 in the manned store MS and an unmanned store priority support organization UG1 that preferentially receives a call start request for starting remote customer service from the store terminal 1c2 in the unmanned store US. Note that there may be three or more priority support organizations.

Further, the manned store priority support organization MG1 includes a support organization SR11 for a skill SK1 and a support organization SR12 for a skill SK2. For example, the skill SK1 is an explainer's ability to make a proposal about a cruise, and the skill SK2 is an explainer's ability to make a proposal about a wedding. In substantially the same manner, the unmanned store priority support organization UG1 includes a support organization SR21 for the skill SK1 and a support organization SR22 for the skill SK2. In other words, the manned store priority support organization MG1 and the unmanned store priority support organization UG1 include the support organization SR11 and the support SR21 (or the support organization SR12 and the support organization SR22) in which the explainers having the same skill are present respectively. There may be three or more skills and three or more skill support organizations.

Furthermore, in the manned store priority support organization MG1, an explainer mg11 and an explainer mg12 each having the skill SK1 are present in the support organization SR11 for the skill SK1. The explainer mg11 uses an explainer terminal 9mg11, and the explainer mg12 uses an explainer terminal 9mg12.

Further, an explainer mg21 and an explainer mg22 each having the skill SK2 are present in the support organization SR12 for the skill SK2. The explainer mg21 uses an explainer terminal 9mg21, and the explainer mg22 uses an explainer terminal 9mg22.

In substantially the same manner, in the unmanned store priority support organization UG1, an explainer ug11 and an explainer ug12 each having the skill SK1 are present in the support organization SR21 for the skill SK1. The explainer ug11 uses an explainer terminal 9ug11, and the explainer ug12 uses an explainer terminal 9ug12. Further, an explainer ug21 and an explainer ug22 each having the skill SK2 are present in the support organization SR22 for the skill SK2. The explainer ug21 uses an explainer terminal 9ug21, and the explainer ug22 uses an explainer terminal 9ug22.

Note that three or more explainers may present in each support organization (SR11, SR12, SR21, SR22). In this case, an explainer terminal is assigned to each of the three or more explainers. In the following description, the plurality of explainer terminals such as the explainer terminals 9mg11, 9mg12, 9mg21, 9mg22, 9ug12, 9ug12, 9ug21 and 9ug22 are collectively referred to as a “explainer terminal 9” or “explainer terminals 9” to simplify the description.

Further, the travel agency has an administrator adl who manages terminals in each service area. The administrator ad1 accesses a service information management apparatus 7 via the communication network 100 by using an administrator terminal 4, to set various service information. This service information is information regarding processing and settings of each terminal of the travel agency. The administrator terminal 4 is configured by a PC.

A customer c1 and a customer c2 are persons who visit the manned store MS and the unmanned store US, respectively.

The system provider manages and operates a relay apparatus 3, a communication management apparatus 5, and the service information management apparatus 7. The relay apparatus 3, the communication management apparatus 5, and the service information management apparatus 7 are computers such as servers. The relay apparatus 3 relays image data and audio data when a video call is performed between any of the store terminals 1 and any of the explainer terminals 9. The communication management apparatus 5 centrally controls login authentication of the store terminals 1 and the explainer terminals 9, management of the communication state of the store terminals 1 and the explainer terminals 9, management of a destination list, and management of the communication state of the relay apparatus 3. The service information management apparatus 7 manages the various types of service information that are set. A detailed description is given below of the relay apparatus 3, the communication management apparatus 5, and the service information management apparatus 7.

The store terminals 1, the administrator terminal 4, the explainer terminals 9, the relay apparatus 3, the communication management apparatus 5, and the service information management apparatus 7 can be connected to the communication network 100 such as the Internet.

The relay apparatus 3, the communication management apparatus 5, and the service information management apparatus 7 may be implemented by a single computer or may be implemented by a plurality of computers to which one or more units (functions or means) are arbitrarily allocated.

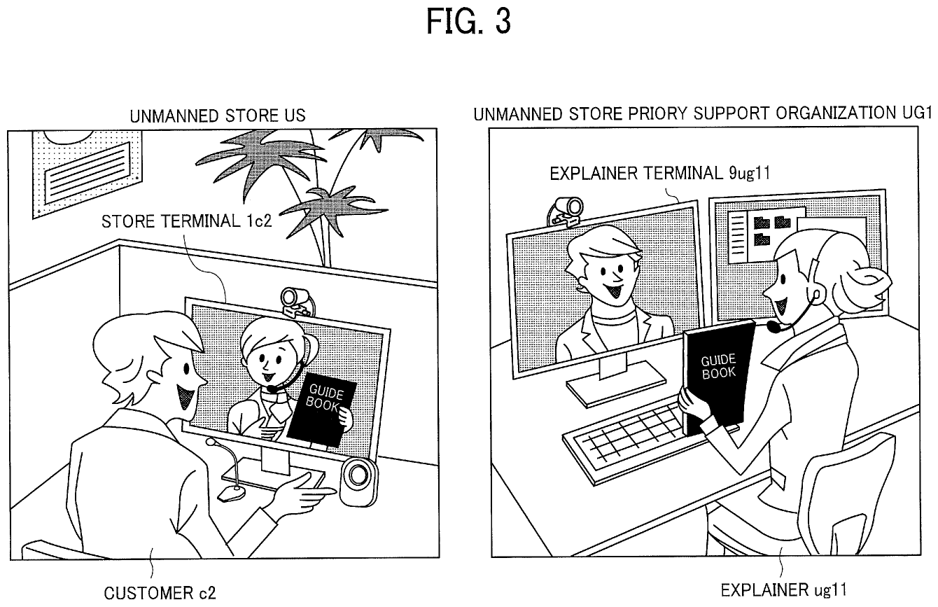

FIG. 3 is an illustration of a situation in which a customer in a store and an explainer in a service center are remotely performing a video call. FIG. 3 illustrates a state in which the customer c2 who visits the unmanned store US uses the store terminal 1c2 and the explainer ug11 in the unmanned store priority support organization UG1 uses the explainer terminal 9ug11. In this way, the customer c2 can receive the explanation of a travel product by a remote service.

Hardware Configuration of Communication System:

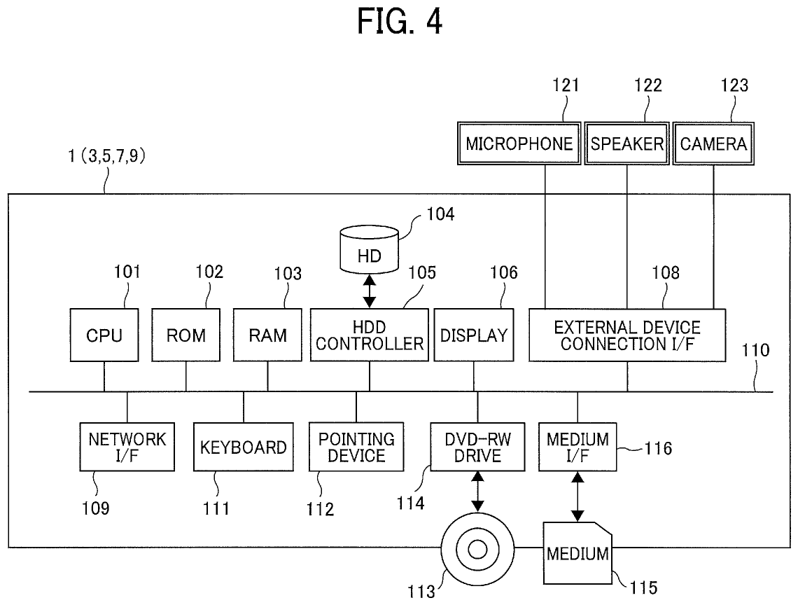

Referring to FIG. 4, a description is now given of each terminal (the store terminal 1, the administrator terminal 4, the explainer terminal 9 and each apparatus (the relay apparatus 3, the communication management apparatus 5, the service information management apparatus 7) of the communication system 2 illustrated in FIG. 2. In the present embodiment, assuming that each terminal and apparatus have the same configuration, the hardware configuration of the store terminal 1 is described, and descriptions of the hardware configurations of other terminals and apparatus are omitted to simplify the description.

As illustrated in FIG. 4, the store terminal 1 is implemented by a computer. The store terminal 1 includes a central processing unit (CPU) 101, a read only memory (ROM) 102, a random access memory (RAM) 103, a hard disk (HD) 104, a hard disk drive (HDD) controller 105, a display 106, an external device connection interface (I/F) 108, network I/F 109, a bus line 110, a keyboard 111, a pointing device 112, a digital versatile disc rewritable (DVD-RW) drive 114 and a medium I/F 116.

The CPU 101 controls entire operation of the computer. The ROM 102 stores a control program such as an initial program loader (IPL) to boot the CPU 101. The RAM 103 is used as a work area for the CPU 101. The HD 104 stores various data such as a control program. The HDD controller 105 controls reading or writing of various data from or to the HD 104 under the control of the CPU 101. The display 106 displays various information such as a cursor, menu, window, characters, or image. The external device connection I/F 108 is an interface circuit that connects the computer to various external devices. Examples of the external devices include, but are not limited to, a universal serial bus (USB) memory and a printer. The network I/F 109 is an interface that controls communication of data between the computer and an external device through the communication network 100. The bus line 110 is, for example, an address bus or a data bus, which electrically connects the elements, such as the CPU 101 illustrated in FIG. 4, each other.

The keyboard 111 is an example of an input device provided with a plurality of keys for allowing a user to input characters, numerals, or various instructions. The pointing device 112 is an example of an input device that allows a user to select or execute a specific instruction, select a target for processing, or move a cursor being displayed. The DVD-RW drive 114 controls reading or writing of various data from or to a DVD-RW 113, which is an example of a removable storage medium. The removable storage medium is not limited to the DVD-RW and may be a digital versatile disc-recordable (DVD-R), a Blu-ray disk, or the like. The medium I/F 116 controls reading or writing of data from or to a storage medium 115 such as a flash memory.

Further, a microphone 121, a speaker 122, and a camera 123 are connected to the external device connection I/F 108. The microphone 121 is an example of an audio collecting device. The speaker 122 is an example of an audio output device. The camera 123 is an example of an imaging device. Although in FIG. 4, the microphone 121, the speaker 122, and the camera 123 are illustrated as external devices, this is just an example. In another example, the microphone 121, the speaker 122, and the camera 123 are built in the computer without the external device connection I/F 108.

Functional Configuration of Communication System:

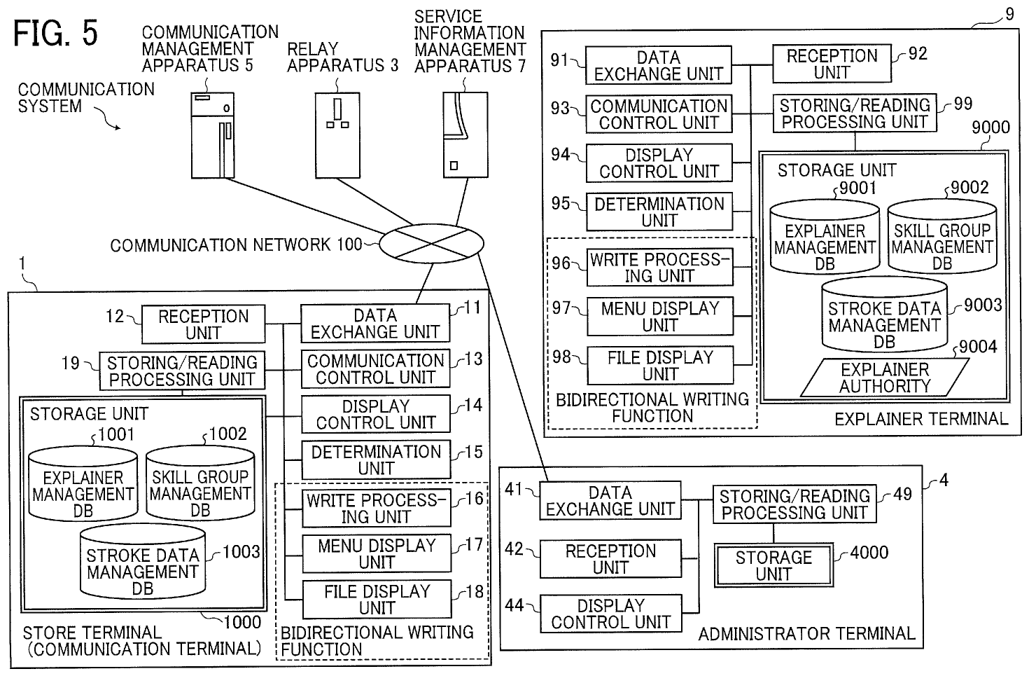

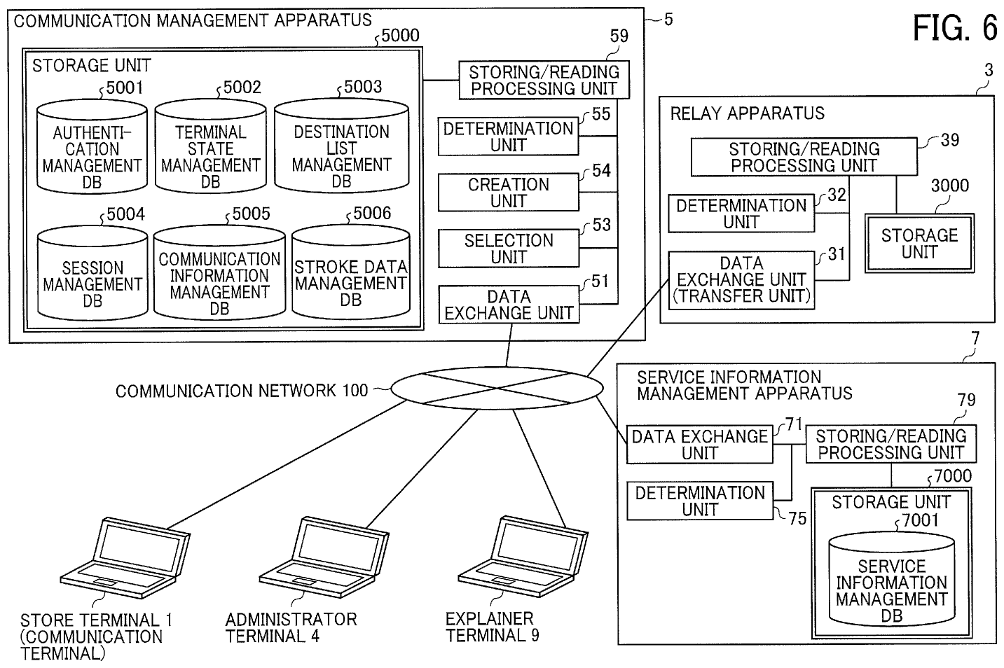

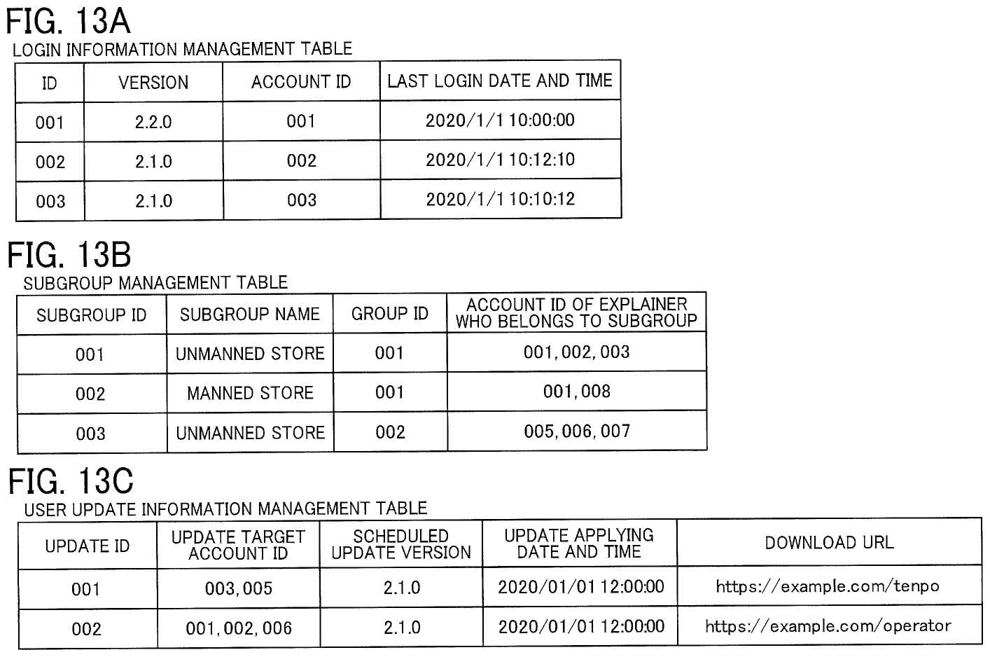

A description is now given of a functional configuration of the communication system 2 according to the present embodiment, with reference to FIG. 5 to FIG. 13 (FIG. 13A to FIG. 13C). FIG. 5 and FIG. 6 are block diagrams each illustrating an example of a functional configuration of the communication system 2 according to the present embodiment.

Functional Configuration of Store Terminal:

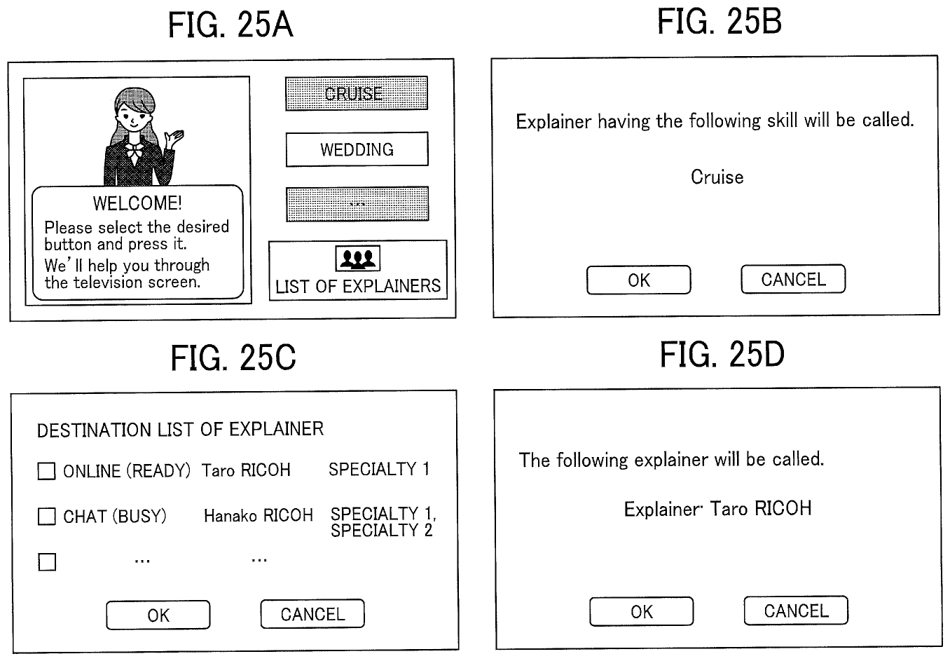

First, a functional configuration of the store terminal 1 is described with reference to FIG. 4 and FIG. 5. As illustrated in FIG. 5, the store terminal 1 includes a data exchange unit 11, a reception unit 12, a communication control unit 13, a display control unit 14, a determination unit 15, a write processing unit 16, a menu display unit 17, a file display unit 18, and a storing/reading processing unit 19. These units are functions that are implemented by or that are caused to function by operating any of the hardware components illustrated in FIG. 4 in cooperation with the instructions of the CPU 101 according to the control program expanded from the HD 104 to the RAM 103. The store terminal 1 further includes a storage unit 1000, which is implemented by the RAM 103 and the HD 104 illustrated in FIG. 4. An explainer management database (DB) 1001, a skill group management DB 1002, and a stroke data management DB 1003 are built in the storage unit 1000. Each information item managed in the explainer management DB 1001 and the skill group management DB 1002 is included in client information transmitted from the service information management apparatus 7 in step S19 described below. Then, the store terminal 1 uses each information item managed in the explainer management DB 1001 and the skill group management DB 1002 to display a screen illustrated in FIG. 25 described below. The stroke data management DB 1003 stores the stroke data representing the strokes written by the customer and the stroke data representing the strokes written by the explainer and transmitted from the explainer terminal 9.

Explainer Management Table:

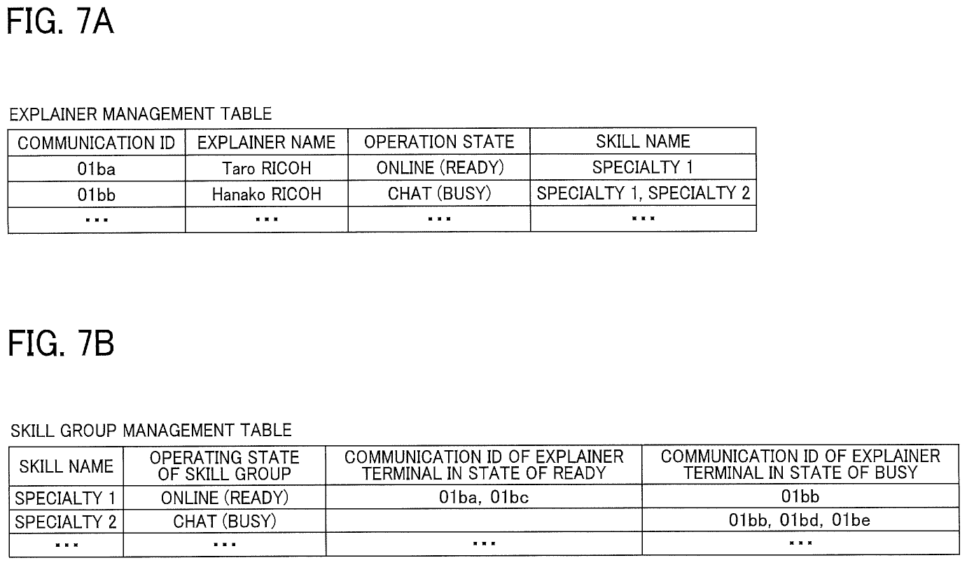

FIG. 7A is a conceptual diagram illustrating an example of an explainer management table. In the storage unit 1000, the explainer management DB 1001 storing the explainer management table as illustrated in FIG. 7A is stored. The explainer management table stores various kinds of information (communication ID, explainer name, operating state (presence) of a destination candidate) of the destination candidate (in this example, the explainer terminal 9) of the store terminal 1 and a skill name indicating a skill of the explainer who individually uses the explainer terminal, in association with each other.

The communication ID, which may be referred to as a contact ID, is identification information identifying a communication destination in the communication system 2. Examples of the communication ID include, but are not limited to, a user ID identifying an explainer who uses the explainer terminal 9, a communication ID identifying a store terminal. The explainer name in FIG. 7A is the explainer name illustrated in FIG. 25C described below. The operating state indicates an operating state of the terminal as a counterpart of the video call. There are three types of operating state, i.e., Online (ready), Chat (busy), and Offline (unavailable). The operating state is reflected in the displays of FIG. 25A and FIG. 25C. As described above, the skill indicates the name of the skill possessed by the explainer. As illustrated in FIG. 7A, one explainer can have a plurality of skills (specialty 1, specialty 2).

Skill Group Management Table:

FIG. 7B is a conceptual diagram illustrating a skill group management table. In the storage unit 1000, the skill group management DB 1002 storing the skill group management table as illustrated in FIG. 7B is stored. The skill group management table stores the skill name, the operating state (presence) of the skill group, the communication ID of the explainer terminal which is in the state of ready to communicate with the store terminal, and the communication ID of the explainer tetminal which is in the state of busy, in association with each other.

The operating state of the skill group indicates an operating state of the explainer terminals as a whole of a group of explainers having the same skill such as the specialty 1. For example, if there are plural explainer terminals of a group of explainers having the same skill, when the operating state of any one of these explainer terminals is “Online”, the operating state of the skill group of the specialty 1 is managed as “Online”. Further, when at least one of the operating states of the plural explainer terminals is “Chat”, the operating state of the skill group of specialty 1 are managed as “Chat”. In other words, when the operating state of the skill group indicates “Chat”, this does not mean all the operating states of the plural explainer terminals are “Online” Further, when all the operating states of the plural explainer terminals are neither “Online” nor “Chat”, in other words, when all the operating states are “Offline”, the operating state of the skill group of specialty 1 are managed as “Offline”.

Each Functional Unit of Configuration of Store Terminal:

Next, each functional unit of the store terminal 1 is described according to the embodiment. The data exchange unit 11, which is implemented by instructions of the CPU 101, the external device connection I/F 108, and the network I/F 109, illustrated in FIG. 4, transmits and receives various data (or information) to and from other terminal, apparatus, and system through the communication network 100.

The reception unit 12, which is mainly implemented by instructions of the CPU 101, the keyboard 111, the pointing device 112, illustrated in FIG. 4, an operation key, or a power switch, receives various inputs from the user.

The communication control unit 13, which is implemented by instructions of the CPU 101 illustrated in FIG. 4, inputs, from an external camera connected to the external device connection I/F 108, image data obtained by capturing an object by the external camera. Further, the communication control unit 13 inputs audio data obtained by collecting sound from an external microphone connected to the external device connection I/F 108. Furthermore, the communication control unit 13 outputs image data received from the other party of the video call and image data obtained by the store terminal 1 itself to the display control unit 14. Still further, the communication control unit 13 outputs audio data received from the other party of the video call and the audio data obtained by the store terminal itself to an external speaker connected to the external device connection I/F 108.

The display control unit 14, which is mainly implemented by instructions of the CPU 101 illustrated in FIG. 4, outputs image data to the display 106 or an external display connected to the external device connection I/F 108, to control the display 106 or the external display to display an image.

The determination unit 15, which is implemented by instructions of the CPU 101 illustrated in FIG. 4, performs various determinations. A detailed description is given below of determinations made by the determination unit 15.

The writing processing unit 16 performs processing related to writing and synchronizing stroke data. The stroke data management DB 1003 stores the stroke data. The stroke data is transmitted to another communication terminal during communication for synchronization. Further, when the restriction is set on the operations from the explainer terminal 9, the stroke data is processed according to the restriction. The menu display unit 17 displays an operation menu (document operation button, operation restriction button, stroke edit button, etc.) operated by the explainer or the customer on the writable window. The menu display unit 17 checks a role of the operator (user), and displays the stroke edit button on the store terminal 1. The explainer terminal 9 checks a role of the operator (user) and displays the document operation button, the operation restriction button, and the stroke edit button.

The file display unit 18 displays image data of a file such as a document on the writable window. The file is converted into image data on a page-by-page basis. The pages converted from the file are switchable with each other to be displayed one by one.

The storing/reading processing unit 19, which is implemented by instructions of the CPU 101 and by the HDD controller 105 illustrated in FIG. 4, performs processing to store various types of data in the storage unit 1000 or read various types of data stored in the storage unit 1000.

Further, each time image data and audio data are received in performing communication with other terminal, the image data and audio data stored in the storage unit 1000 are overwritten. The display 106 or the external display displays an image based on image data before being overwritten, and the external speaker outputs sound based on audio data before being overwritten.

Administrator Terminal:

A description is now given of a functional configuration of the administrator terminal 4 according to the present embodiment, with reference to FIG. 4 and FIG. 5. As illustrated in FIG. 5, the administrator terminal 4 includes a data exchange unit 41, a reception unit 42, a display control unit 44, and a storing/reading processing unit 49. The administrator terminal 4 further includes a storage unit 4000, which is implemented by the RAM 103 and the HD 104 illustrated in FIG. 4.

The data exchange unit 41, the reception unit 42, the display control unit 44, and the storing/reading processing unit 49 of the administrator terminal 4 have the same or the substantially the same functions as the data exchange unit 11, the reception unit 12, the display control unit 14, and the storing/reading processing unit 19 of the store terminal 1, and therefore the redundant descriptions thereof are omitted below to simplify the description.

Functional Configuration of Explainer Terminal:

A description is now given of a functional configuration of the explainer terminal 9 according to the present embodiment, with reference to FIG. 4 and FIG. 5. As illustrated in FIG. 5, the explainer terminal 9 includes a data exchange unit 91, a reception unit 92, a communication control unit 93, a display control unit 94, a determination unit 95, a write processing unit 96, a menu display unit 97, a file display unit 98, and a storing/reading processing unit 99. The explainer terminal 9 further includes a storage unit 9000, which is implemented by the RAM 103 and the HD 104 illustrated in FIG. 4. An explainer management DB 9001, a skill group management DB 9002, a stroke data management DB 9003, and information on explainer authority 9004 are built in the storage unit 9000.

The data exchange unit 91, the reception unit 92, the communication control unit 93, the display control unit 94, the determination unit 95, the write processing unit 96, the menu display unit 97, the file display unit 98, and the storing/reading processing unit 99 of the explainer terminal 9 have the same or the substantially the same functions as the data exchange unit 11, the reception unit 12, the communication control unit 13, the display control unit 14, the determination unit 15, the write processing unit 16, the menu display unit 17, the file display unit 18, and the storing/reading processing unit 19 of the store terminal 1, and therefore the redundant descriptions thereof are omitted below to simplify the description. Further, the explainer management DB 9001, the skill group management DB 9002, and the stroke data management DB 9003 of the explainer terminal 9 have the same or substantially the same data structure as the explainer management DB 1001, the skill group management DB 1002, and the stroke data management DB 1003 of the store terminal 1, and therefore redundant descriptions thereof are omitted below to simplify the description. The explainer authority 9004 is one of the privileges of the explainer, and the explainer authority 9004 permits the explainer to set the restriction on the operations of the store terminal 1. The explainer authority 9004 is generated (or assigned from the communication management apparatus 5) for the role of explainer. The explainer authority 9004 may be assigned from an explainer to another explainer.

Functional Configuration of Relay Apparatus:

A description is now given of a functional configuration of the relay apparatus 3 according to the present embodiment, with reference to FIG. 4 and FIG. 6. As illustrated in FIG. 6, the relay apparatus 3 includes a data exchange unit 31 that also functions as a transfer unit, a determination unit 32, and a storing/reading processing unit 39. These units are functions implemented by or caused to function by operating any of the hardware elements illustrated in FIG. 4 in cooperation with instructions of the CPU 101 according to the control program expanded from the HD 104 to the RAM 103. The relay apparatus 3 further includes a storage unit 3000, which is implemented by the RAM 103 and the HD 104 illustrated in FIG. 4.

Functional Unit of Relay Apparatus:

A description is now given of each of the functional units of the relay apparatus 3 in detail. The data exchange unit 31 of the relay apparatus 3 illustrated in FIG. 6, which is implemented by instructions of the CPU 101 illustrated in FIG. 4 and by the network I/F 109 illustrated in FIG. 4, transmits and receives various types of data (or information) to and from other terminal, apparatus, or system via the communication network 100. The data exchange unit 31 also functions as a transfer unit, which transfers video data and audio data transmitted from a particular terminal to another terminal.

The determination unit 32, which is implemented by instructions of the CPU 101 illustrated in FIG. 4, determines delay of data transmission.

The storing/reading processing unit 39, which is implemented by instructions of the CPU 101 illustrated in FIG. 4 and by the HD 104 illustrated in FIG. 4, performs processing to store various types of data in the storage unit 3000 or read various types of data stored in the storage unit 3000.

Functional Configuration of Communication Management Apparatus:

A description is now given of a functional configuration of the communication management apparatus 6 according to the present embodiment, with reference to FIG. 4 and

FIG. 6. As illustrated in FIG. 6, the communication management apparatus 5 includes a data exchange unit 51, a selection unit 53, a creation unit 54, a determination unit 55, and a storing/reading processing unit 59. These units are functions implemented by or caused to function by operating any of the hardware elements illustrated in FIG. 5 in cooperation with instructions of the CPU 101 according to the control program expanded from the HD 104 to the RAM 103. The communication management apparatus 5 further includes a storage unit 5000, which is implemented by the RAM 103 and the HD 104 illustrated in FIG. 4.

Authentication Management Table:

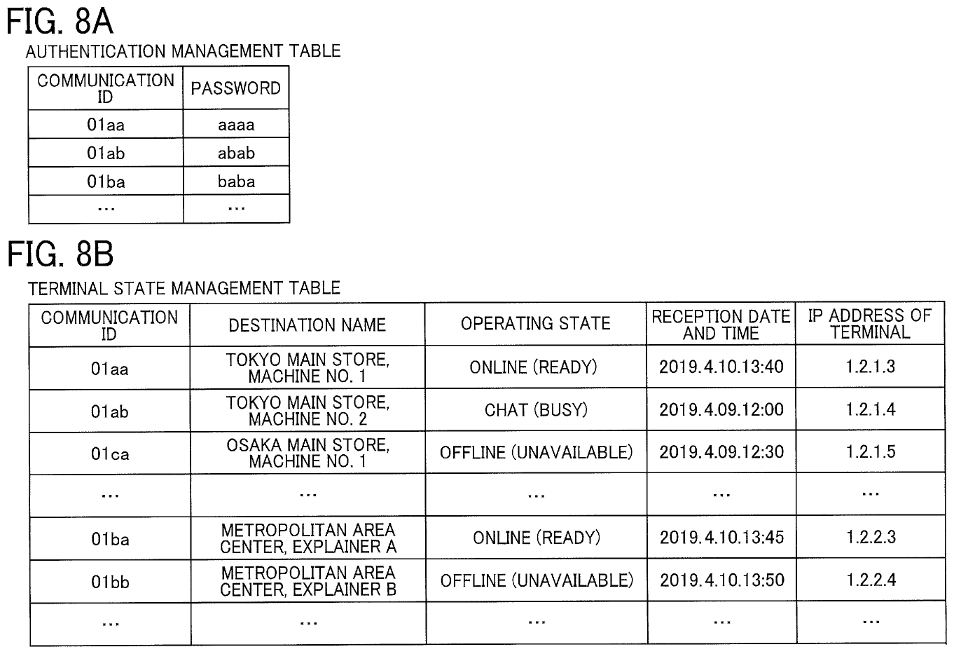

FIG. 8A is a conceptual diagram illustrating an authentication management table.

The storage unit 5000 stores the authentication management DB 5001, which is configured by the authentication management table as illustrated in FIG. 8A. The authentication management table stores, for each one of the store terminals 1 and the explainer terminals 9 managed by the communication management apparatus 5, the communication ID and the password in association with each other. The password is an example of authentication information. The authentication information also includes an access token.

Terminal State Management Table:

FIG. 8B is a conceptual diagram illustrating a terminal state management table. In the storage unit 5000, a terminal management DB 5002 storing a terminal state management table as illustrated in FIG. 8B is stored. The terminal state management table stores, for each of the communication IDs of the store terminals 1 and the explainer terminals 9, a destination name as each of the store terminals 1 and the explainer terminals 9 being a destination, an operating state of each of the store terminals 1 and the explainer terminals 9, a reception date and time when login information described below is received at the communication management apparatus 5, and an Internet protocol (IP) address of each the store terminals 1 and the explainer terminals 9, in association with each other. Note that the communication ID, the destination name, and the IP address of the terminal are stored when each of the store terminals 1 and the explainer terminals 9 is pre-registered to receive service provided by the communication management apparatus 5.

Destination List Management Table:

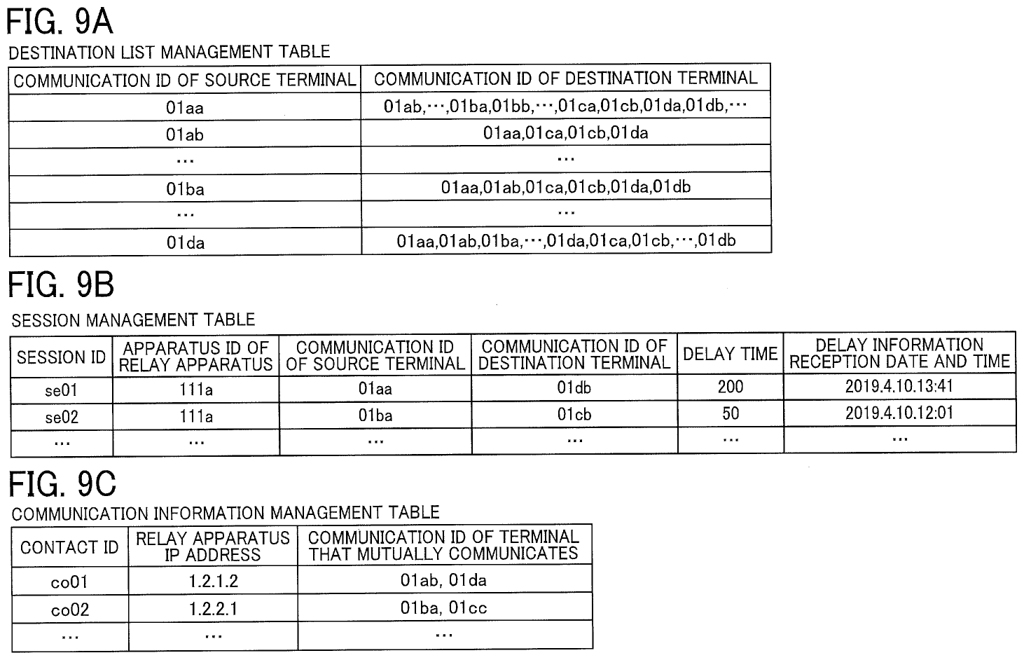

FIG. 9A a conceptual diagram illustrating a destination list management table. In the storage unit 5000, a destination list management DB 5003 storing a destination list management table as illustrated in FIG. 9A is stored. The destination list management table stores the communication ID of the terminal (source terminal) that requests to start a call, in association with the communication IDs of all destination terminals registered as candidate destination terminals for the source terminal. The information on such destination terminal candidates is updated by addition or deletion in response to an addition or deletion request transmitted from the administrator terminal 4 to the communication management apparatus 5.

The destination list is an example of destination information. In another example, the destination information can be arrangement of pieces of information relating to the destinations such as the communication ID.

Session Management Table:

FIG. 9B a conceptual diagram illustrating a session management table. The storage unit 5000 stores a session management DB 5004, which is configured by the session management table as illustrated in FIG. 9B. The session management table stores, for each communication session ID identifying a session to perform mutual communication between each terminal and the relay apparatus 3, a relay apparatus ID of the relay apparatus 3 involved in the session, a communication ID of the source terminal, a communication ID of the destination terminal, a delay time (ms) in receiving image data at the destination terminal, and delay information reception date and time indicating when delay information indicating that the delay time is transmitted from the destination terminal and received by the communication management apparatus 5, in association with each other.

Communication Information Management Table:

FIG. 9C is a conceptual diagram illustrating a communication information management table. In the storage unit 5000, a communication information management DB 5005 storing the communication information management table as illustrated in FIG. 9C is stored. The communication information management table stores, for each communication (contact) ID identifying mutual communication performed between each terminal and the relay apparatus 3, an IP address of the relay apparatus 3 involved in the mutual communication and the communication IDs of the terminals that perform the mutual communication, in association with each other.

Stroke Data Management Table:

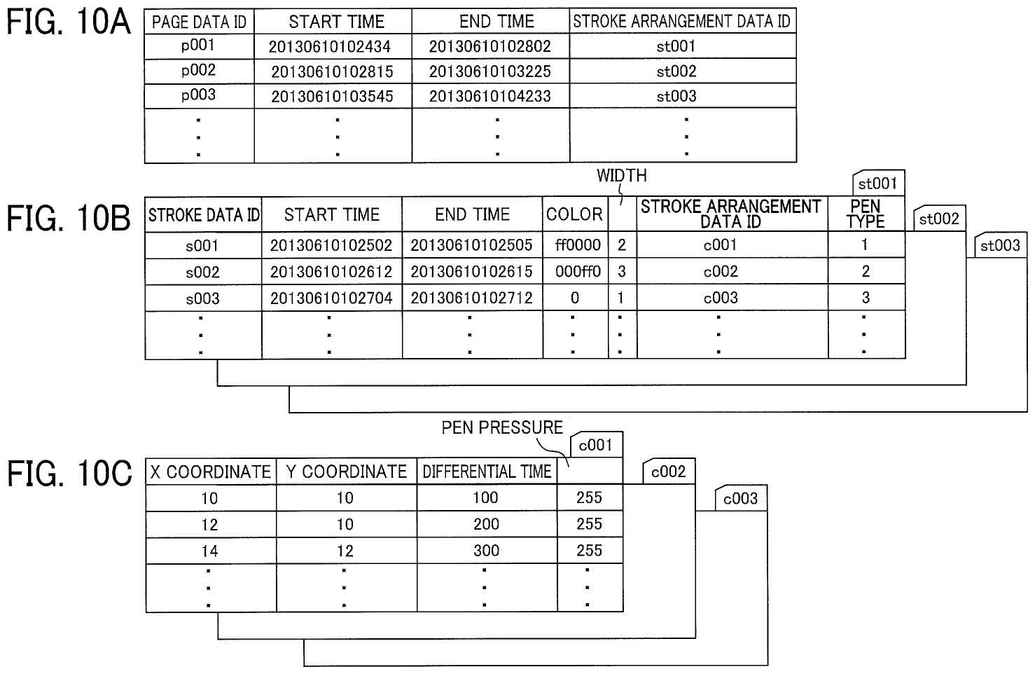

FIG. 10A to FIG. 10C are illustrations each of which is an example data structure of a stroke data management table. The storage unit 5000 stores a stroke data management DB 5006, which is implemented by the stroke data management tables as illustrated in FIG. 10A to FIG. 10C. The stroke data is managed for each page of the writable window.

As illustrated in FIG. 10A, the page data includes a page data ID for identifying a specific page, start time when display of that page is started, end time when drawing to that page by a stroke drawing or a gesture is stopped, and a stroke arrangement data ID for identifying stroke arrangement data, in association with one another. The stroke arrangement data is a set of stroke drawings, which are made by the user with the electronic pen or the user's finger. For example, in case the user draws the alphabet “S” with the electronic pen in one stroke, one stroke data ID is assigned to that stroke drawing “S”. In case the user draws the alphabet “T” with the electronic pen in two strokes, two stroke data IDs are assigned to those two stroke drawings “T”.

The stroke arrangement data includes various information as illustrated in FIG. 10B. FIG. 10B illustrates an example data structure of the stroke arrangement data, according to the present embodiment. As illustrated in FIG. 10B, one stroke arrangement data includes a plurality of items of stroke data, each corresponding to a stroke drawing. Each stroke data includes a stroke data ID for identifying that stroke data, start time when drawing of that stroke starts, end time when drawing of that stroke ends, a color of the stroke, a width of the stroke, and a coordinate arrangement data ID for identifying arrangement of points of the stroke.

The coordinate arrangement data includes various information as illustrated in FIG. 10C. FIG. 10C illustrates an example data structure of the coordinate arrangement data, according to the present embodiment. As illustrated in FIG. 10C, the coordinate arrangement data includes a single point (X coordinate value, Y coordinate value) on the display, difference time (ms) indicating a difference between the time when that point is drawn and the start time when drawing of the stroke starts, and pressure by the electronic pen on that single point. That is, one item of coordinate arrangement data in FIG. 10B is a collection of single points in FIG. 10C. For example, in case in which a user draws the alphabet “S” with the electronic pen in one stroke, a plurality of points is drawn, such that the coordinate arrangement data indicates those points in the stroke drawing.

Each Functional Unit of Communication Management Apparatus:

A description is now given of each of the functional units of the communication management apparatus 5 in detail. In the following description of the functional configuration of the communication management apparatus 5, relationships of one or more hardware elements in FIG. 4 with each functional unit of the communication management apparatus 5 in FIG. 6 will also be described.

The data exchange unit 51 of the communication management apparatus 5 illustrated in FIG. 6, which is implemented by instructions of the CPU 101 and by the network I/F 109 illustrated in FIG. 4, transmits and receives various types of data (or information) to and from other terminal, apparatus, or system via the communication network 100.

The selection unit 53, which is implemented by instructions of the CPU 101 illustrated in FIG. 4, selects an optimum relay apparatus for mutual communication based on the IP address of each terminal.

The creation unit 54, which is implemented by instructions of the CPU 101 illustrated in FIG. 4, creates communication information in response to a mutual communication start request from each terminal. This communication information includes, but not limited to, the IP address of the relay apparatus selected by the selection unit 53 and the above-described communication ID.

The determination unit 55, which is implemented by instructions of the CPU 101 illustrated in FIG. 4, performs various determinations.

The storing/reading processing unit 59, which is implemented by instructions of the CPU 101 and by the HDD controller 105 illustrated in FIG. 4, performs processing to store various types of data in the storage unit 5000 or read various types of data stored in the storage unit 5000.

Service Information Management Apparatus:

A description is now given of a functional configuration of the service information management apparatus 7 according to the present embodiment, with reference to FIGS. 4 and FIG. 6. As illustrated in FIG. 6, the service information management apparatus 7 includes a data exchange unit 71, a determination unit 75, and a storing/reading processing unit 79.

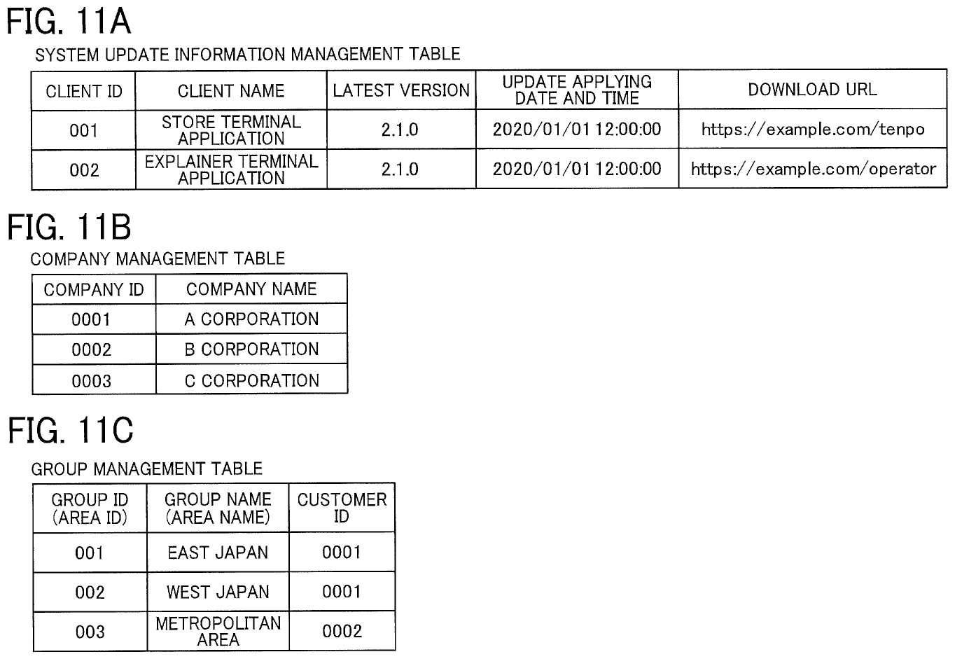

These units are functions implemented by or caused to function by operating any of the hardware elements illustrated in FIG. 4 in cooperation with instructions of the CPU 101 according to the control program expanded from the HD 104 to the RAM 103. The service information management apparatus 7 further includes a storage unit 7000, which is implemented by the RAM 103 and the HD 104 illustrated in FIG. 4. A service information management DB 7001 is built in the storage unit 7000. In the service information management DB 7001, tables illustrated in FIG. 11A to FIG. 11C are stored.

System Update Information Management Table:

FIG. 11A is a conceptual diagram illustrating a system update information management table. The system update information management table stores, for each client ID, a client name, the latest version, an update applying date and time, and a download URL (Uniform Resource Locator), in association with each other. In a column of the client name, a store terminal application is an application for the store terminal 1, and an explainer terminal application is an application for the explainer terminal 9. Each application is managed by each download URL.

Company Management Table:

FIG. 11B is a conceptual diagram illustrating a company management table. The company management table stores a company ID and a company name in association with each other. Examples of the company include, but are not limited to, a travel agency and a leasing company.

Group Management Table:

FIG. 11C is a conceptual diagram illustrating a group management table. The group management table stores, for each group ID, a group name (area name) and the company ID, in association with each other. The group indicates the area E1 or the like in FIG. 1.

Terminal Management Table:

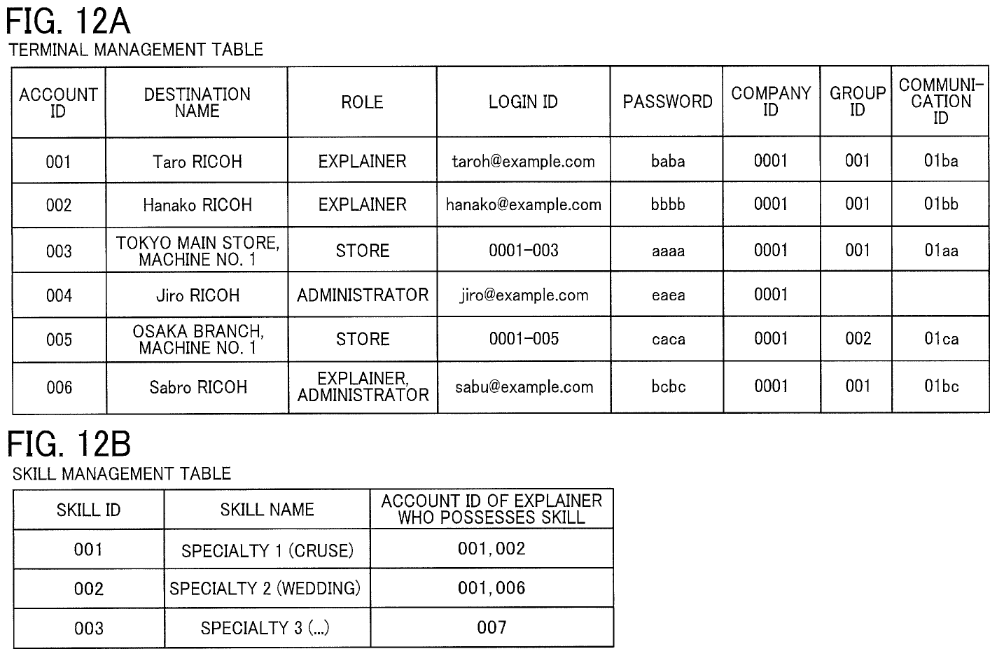

FIG. 12A is a conceptual diagram illustrating a terminal management table. The terminal management table stores, for each account, the destination name, a role, a login ID, a password, the company ID, a group ID, and the communication ID, in association with each other. The account ID is identification information identifying the store, the explainer, and the administrator. With respect to the store, the account of the store itself is stored, instead of the customer. The destination name is also stored in the terminal state management table illustrated in FIG. 8B. The destination name is a display name displayed on a destination selection screen displayed on the store terminal 1 as illustrated in FIG. 25C. The role indicates a role of each user of the communication terminal, and also includes the operation privileges in the present embodiment. The role is determined when the customer or the explainer logs in with a predetermined account, so that the role is based on an account type.

The login ID and the password are used for authentication when the administrator adl accesses the service information management apparatus 7 from the administrator terminal 4. The “password” in this terminal management table is the same as the “password” in the authentication management table in FIG. 8A. However, a different password may be stored. The communication ID is also stored in the terminal state management table (see FIG. 8A) in the communication management apparatus 5.

Skill Management Table:

FIG. 12B is a conceptual diagram illustrating a skill management table. The skill management table stores, for each skill ID, a skill name and the account ID of the explainer who possesses the corresponding skill, in association with each other. As illustrated in FIG. 12B, the skill management table can store information indicating that the same explainer (the account ID “001”) has a plurality of skills such as the specialty 1 and the specialty 2.

Login Information Management Table:

FIG. 13A is a conceptual diagram illustrating a login information management table. The login information management table stores, for each ID of a reference number, a version, the account ID, and a last login date and time, in association with each other.

Subgroup Management Table:

FIG. 13B is a conceptual diagram illustrating a subgroup management table. The subgroup management table stores, for each subgroup ID, a subgroup name, the group ID, and the account ID of the explainer who belongs to the subgroup, in association with each other. As illustrated in FIG. 12B, the skill management table can store information indicating that the same explainer (the account ID “001”) has a plurality of skills such as the specialty 1 and the specialty 2. With respect to the account ID of the store terminal, the subgroup indicates the manned store or the unmanned store, as illustrated in FIG. 13B. Further, with respect to the account ID of the explainer, the subgroup indicates the manned store priority support organization or the unmanned store priority support organization.

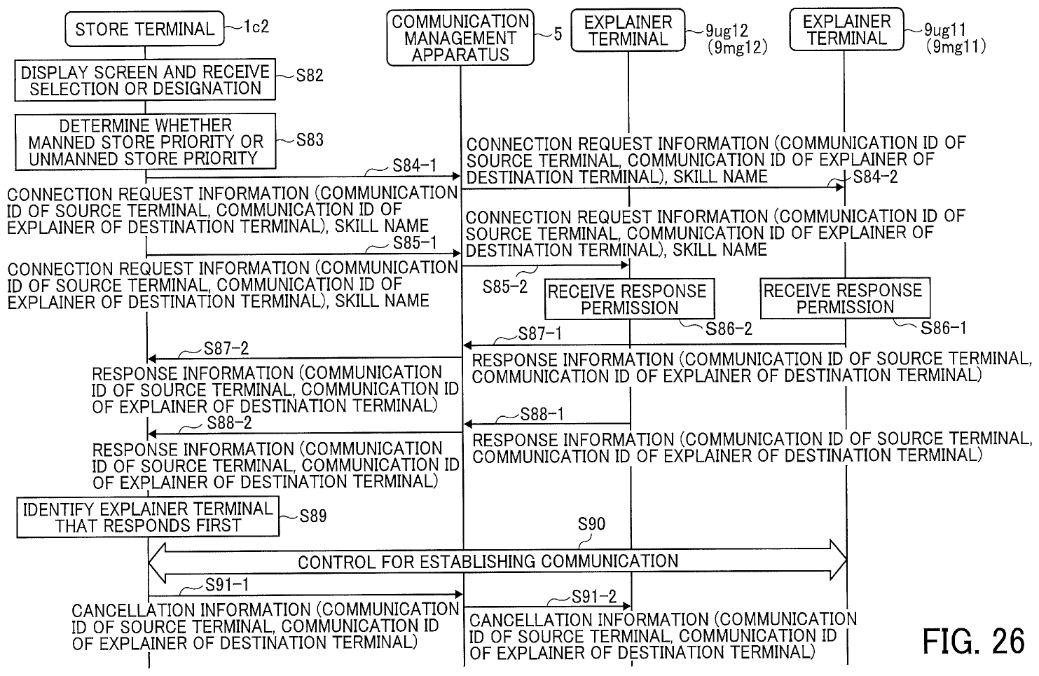

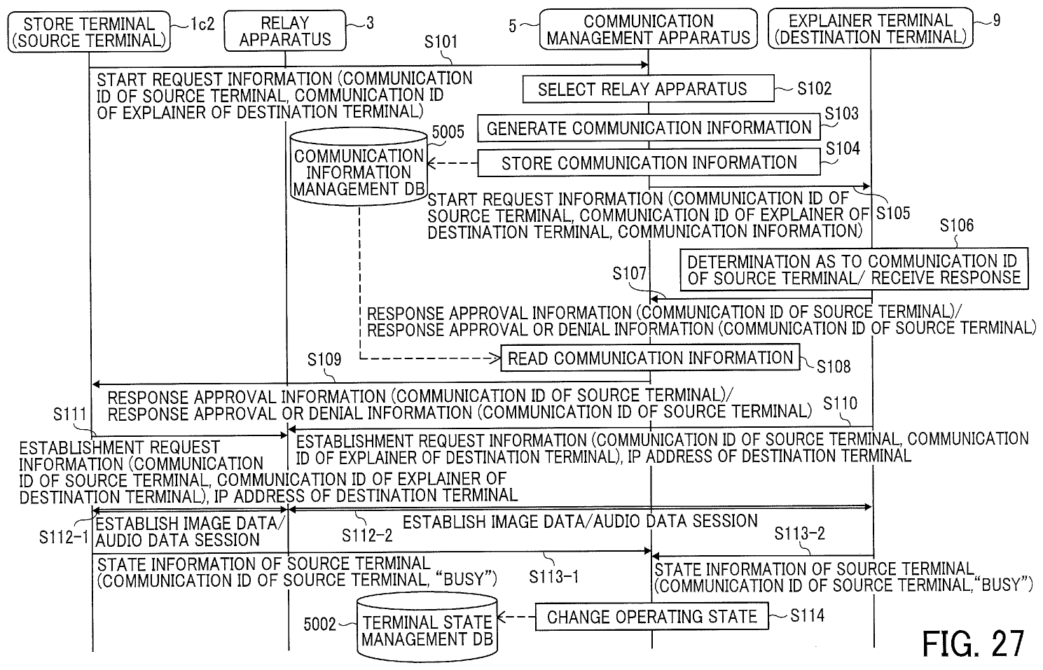

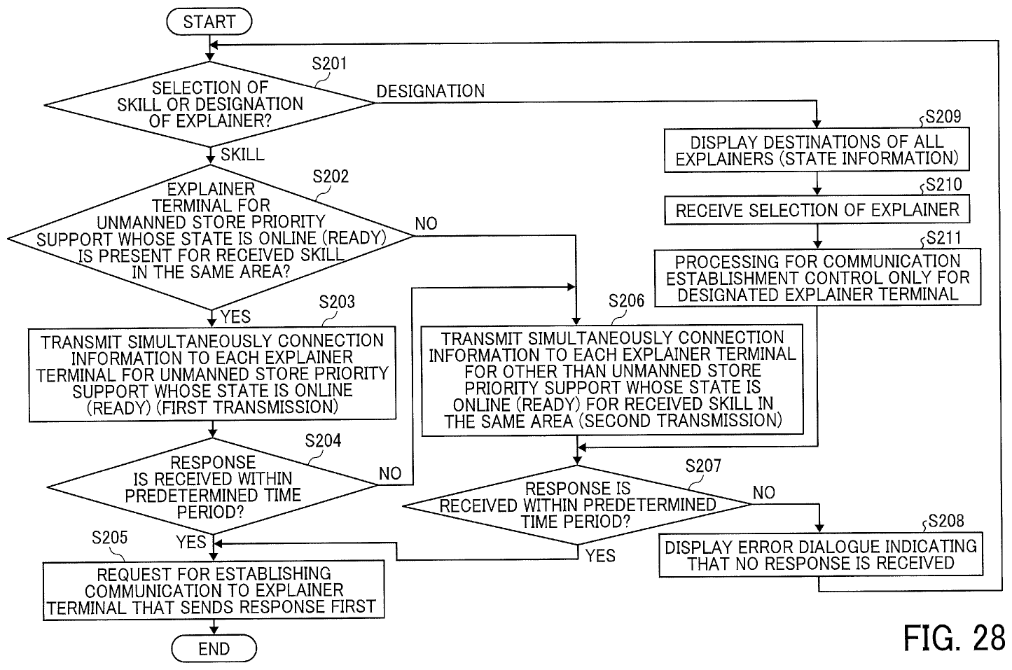

With the subgroup management table, for example, the store terminal whose account ID “003” (Tokyo main store, Machine No. 1) preferentially transmits (first transmission; S84-1, S85-1 of FIG. 26 described below) a connection request information indicating a connection request of a communication session for a video call simultaneously to the explainer terminals used by the explainers whose account IDs “001” and “002”, as a previous step of a start request of the video call (see S101 of FIG. 27). When no response is received within a certain time period from the explainer terminal of the explainer whose account IDs are “001” and “002” (see S204 of FIG. 28 described below), the store terminal whose account ID “003” (Tokyo main store, Machine No. 1) transmits (second transmission) the call start request simultaneously to a predetermined explainer terminal whose operating state is “Online” (ready) among the explainer terminals of the explainers who have the same skill, other than the explainers whose account IDs are “001” and “002” (see S206 in FIG. 28 described below).

User Update Information Management Table:

FIG. 13C is a conceptual diagram illustrating a user update information management table. The user update information management table stores, for each update ID, an update target account ID, a scheduled update version, the update applying date and time, and the download URL, in association with each other.

Each Functional Unit of Service Information Management Apparatus:

A description is now given of each of the functional units of the service information management apparatus 7 in detail. In the following description of the functional unit of the service information management apparatus 7, relationships of one or more hardware elements in FIG. 4 with each functional unit of the service information management apparatus 7 will also be described.

The data exchange unit 71 of the service information management apparatus 7 illustrated in FIG. 6, which is implemented by instructions of the CPU 101 and by the network I/F 109 illustrated in FIG. 4, transmits and receives various types of data (or information) to and from other terminal, apparatus, or system via the communication network 100.

The determination unit 75, which is implemented by instructions of the CPU 101 illustrated in FIG. 4, performs various determinations.

The storing/reading processing unit 79, which is implemented by instructions of the CPU 101 and by the HDD controller 105 illustrated in FIG. 4, performs processing to store various types of data in the storage unit 7000 or read various types of data stored in the storage unit 7000.

Processes or Operation of Embodiment:

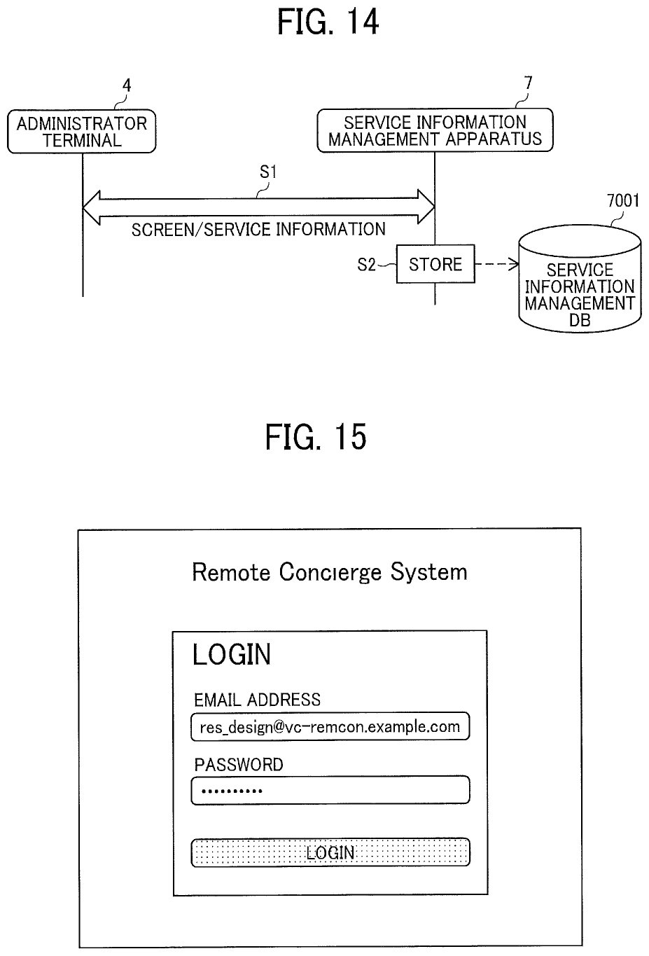

A description is now given of processes of operation performed by the communication system 2 according to the present embodiment, with reference to FIG. 14 to FIG. 26. In the following description, the store terminal 1 that sends a request for starting a video call may be referred to as a “source terminal”, and the explainer terminal 9 as a request destination (relay destination) to which the request is to be transmitted may be referred to as a “destination terminal”.

Processes of Registering Service Information:

First, a description is given of processes of registering various service information from the administrator terminal 4 to the service information management apparatus 7, with reference to FIG. 14 to FIG. 21. The service information is managed in each table described above with reference to FIG. 11A to FIG. 11C to FIG. 13A to FIG. 13C.

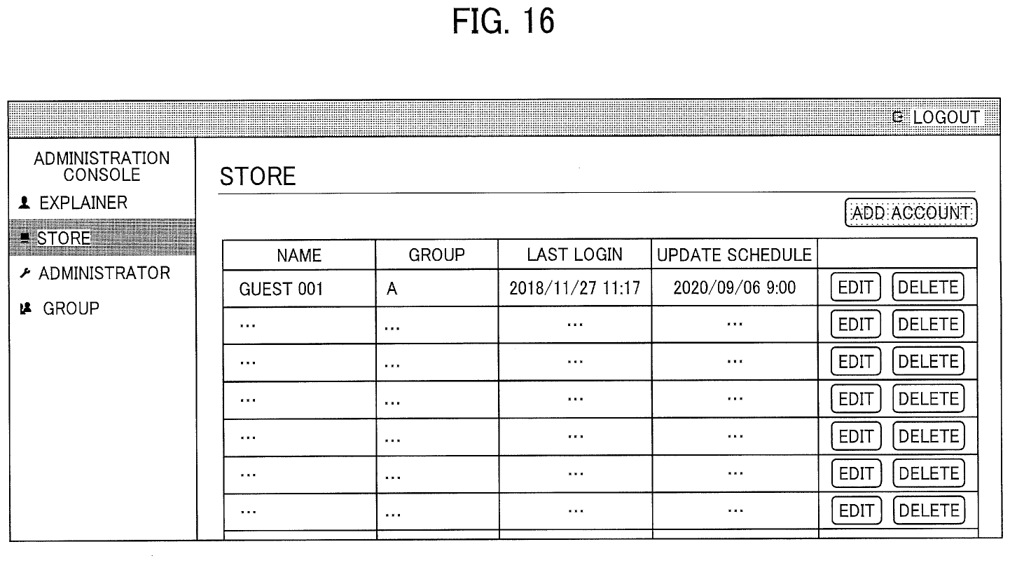

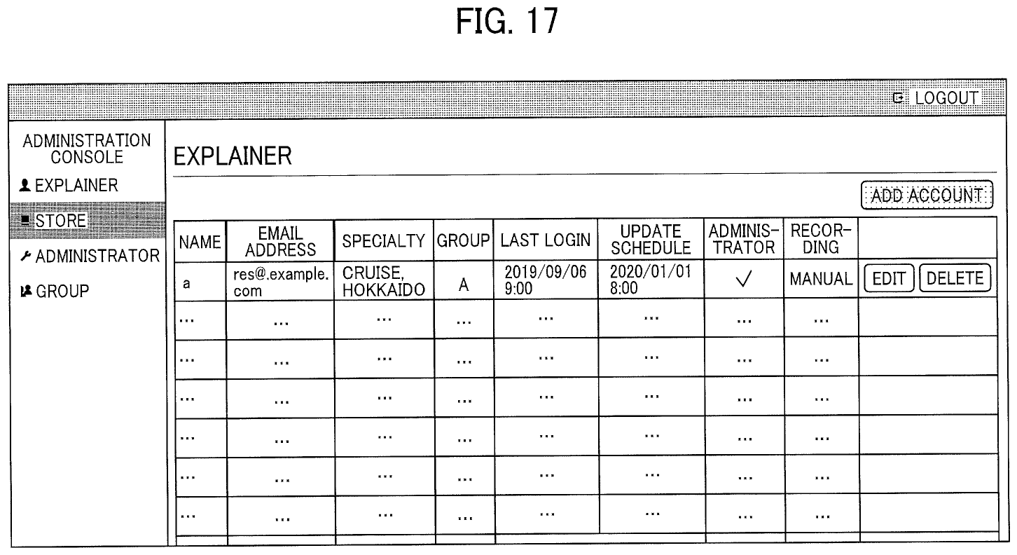

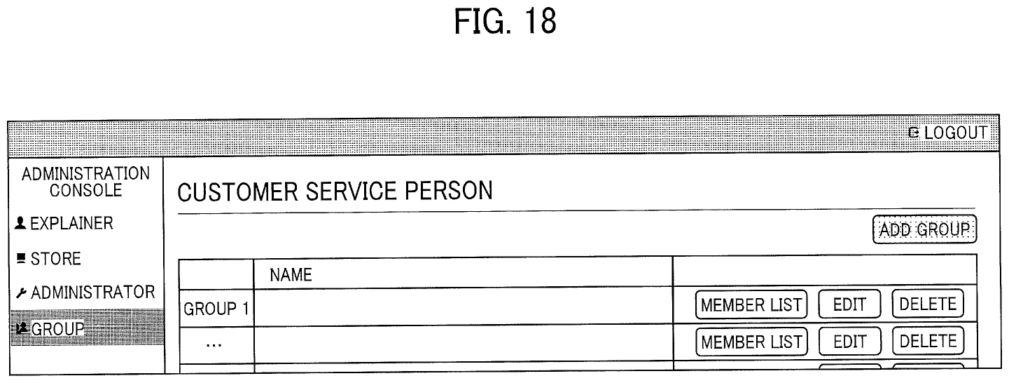

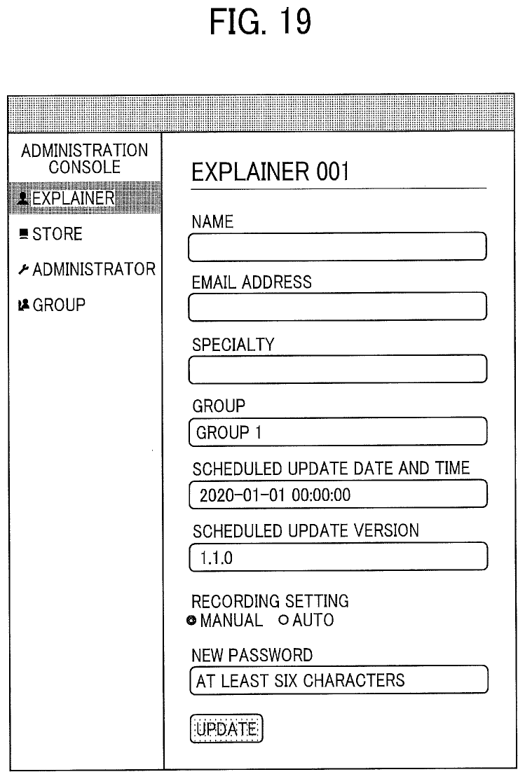

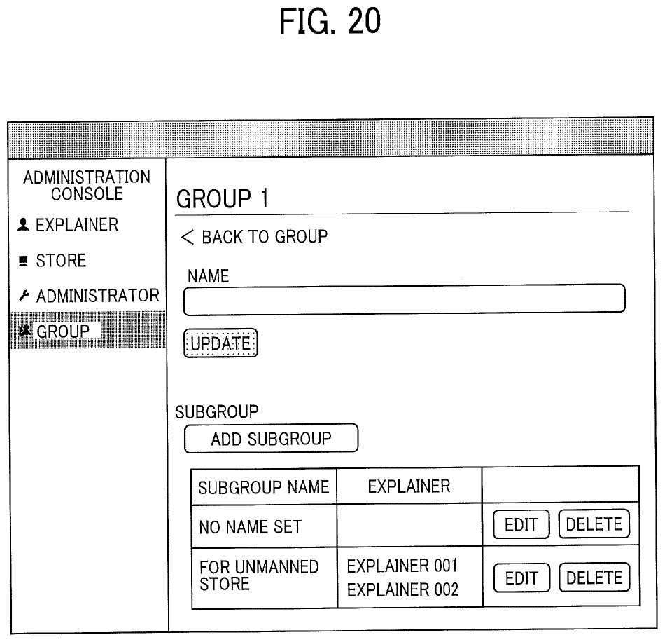

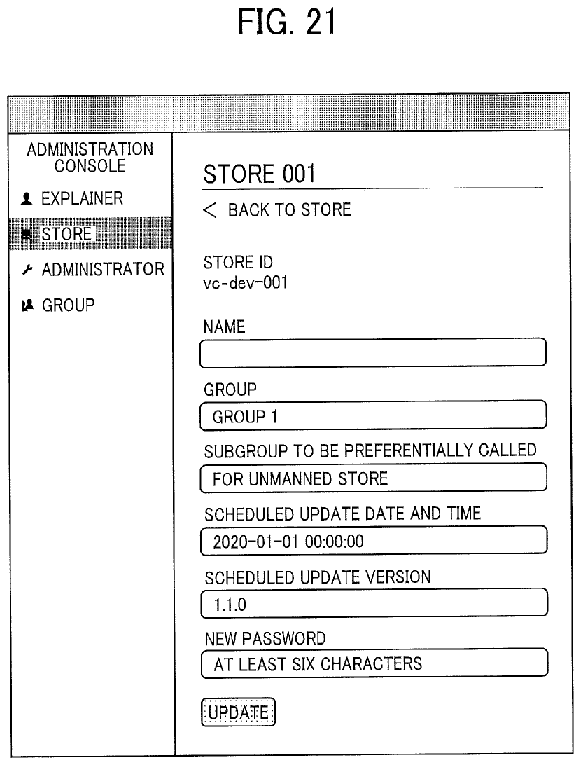

FIG. 14 is a sequence diagram illustrating processing or operation of registering service information. FIG. 15 is a diagram illustrating an example of a login screen displayed on the administrator terminal 4. FIG. 16 is a diagram illustrating an example of a store list screen displayed on the administrator terminal 4. FIG. 17 is a diagram illustrating an example of an explainer list screen displayed on the administrator terminal 4. FIG. 18 is a diagram illustrating an example of a group list screen displayed on the administrator terminal 4. FIG. 19 is a diagram illustrating an example of an explainer information edit screen displayed on the administrator terminal 4. FIG. 20 is a diagram illustrating an example of a group information edit screen displayed on the administrator terminal 4. FIG. 21 is a diagram illustrating an example of a store information edit screen displayed on the administrator terminal 4.

As illustrated in FIG. 14, the administrator ad1 accesses the service information management apparatus 7 using the administrator terminal 4 via the communication network 100. Thereby, a web browser (the display control unit 44) of the administrator terminal 4 controls the display 106 to display the screens of FIGS. 15 to FIG. 21, and the data exchange unit 41 transmits the service information entered or selected on each of the screens by the administrator adl to the service information management apparatus 7 (S1). The data exchange unit 71 of the service information management apparatus 7 receives each service information, and the storing/reading processing unit 79 stores each service information in the service information management DB 7001. Thus, the information is stored in the tables illustrated in FIG. 11 (FIG. 11A to FIG. 11C) to FIG. 13 (FIG. 13A to FIG. 13C).

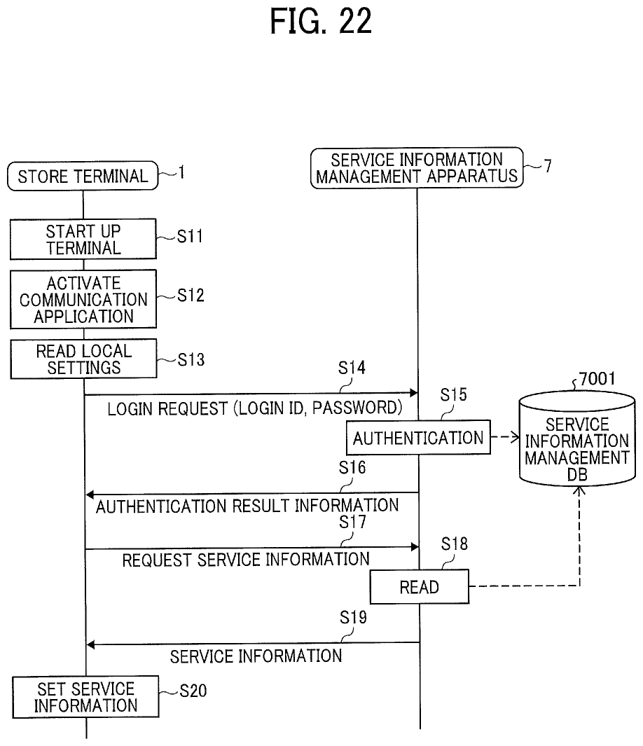

The screens are displayed in the order of FIG. 15 to FIG. 21. For example, on the group information edit screen illustrated in FIG. 20, the administrator adl enters the account ID of the explainer of the explainer terminal 9 to which the administrator wants to transmit the call start request preferentially in a “EXPLAINER” field of the subgroup (for the unmanned store). Further, on the store information edit screen illustrated in FIG. 21, the subgroup name (in this example, “FOR UNMANNED STORE”) is entered in a “SUBGROUP TO BE PREFERENTIALLY CALLED” field. The store terminal 1 acquires the service information from the service information management apparatus 7 (see S19 of FIG. 22 described below), to manage the explainer terminal 9 to which the store terminal 1 preferentially transmits the call start request (see S20).

Processes of Preparing Video Call:

Next, with reference to FIG. 22 to FIG. 25, operation of preparing a video call for a remote customer service is described. FIG. 22 is a sequence diagram illustrating processing or operation of preparing a call of the store terminal 1.

First, when a customer who visits the store turns on a power switch of the store terminal 1, the reception unit 12 receives the turning-on of the power and starts up the store terminal 1 (S11). When the store terminal 1 is started up, a communication application installed in the store terminal 1 is activated (S12). Processes performed by the store terminal 1 in the operation described below are executed by instructions of the communication application. The storing/reading processing unit 19 reads local setting information from the storage unit 1000 (S13). With these processes, the store terminal 1 completes preparation such as a setting of a background image on a display screen, the login ID, and the password.

Next, the data exchange unit 11 of the store terminal 1 transmits a login request to the service information management apparatus 7 via the communication network 100 (S14). This login request includes the login ID and the password read in step S13. The data exchange unit 71 of the service information management apparatus 7 receives the login request. The service information management apparatus 7, which is a receiving side of the login request, acquires the IP address of the store terminal 1, which is a transmitting side of the login request, by receiving the login request transmitted from the store terminal 1 to the service information management apparatus 7.

Next, the deteimination unit 75 of the service information management apparatus 7 searches the terminal management table (FIG. 12A) stored in the service information management DB 7001 using the login ID and the password included in the login request as search keys, to authenticate the store terminal 1 based on determination as to whether the same login ID and password are stored in the terminal management table (S15).

The data exchange unit 71 of the service information management apparatus 7 transmits authentication result information indicating the authentication result to the store terminal 1 (S16). Thereby, the data exchange unit 11 of the store terminal 1 receives the authentication result information.

Next, the data exchange unit 11 of the store terminal 1 transmits a request for service information to the service information management apparatus 7 (S17). Thereby, the data exchange unit 71 of the service information management apparatus 7 receives the request for service information.

Next, the storing/reading processing unit 79 of the service information management apparatus 7 reads the service information from the service information management DB 7001 (S18). As the service information, the information illustrated with the tables illustrated in FIG. 11 (FIG. 11A to FIG. 11C) to FIG. 13 (FIG. 13A to FIG. 13C) is read out. The data exchange unit 71 transmits the service information to the store terminal 1 (S19). Thereby, the data exchange unit 11 of the store terminal 1 receives the service information. Next, the storing/reading processing unit 19 of the store terminal 1 sets the service information (S20).

Processes of Starting Video Call:

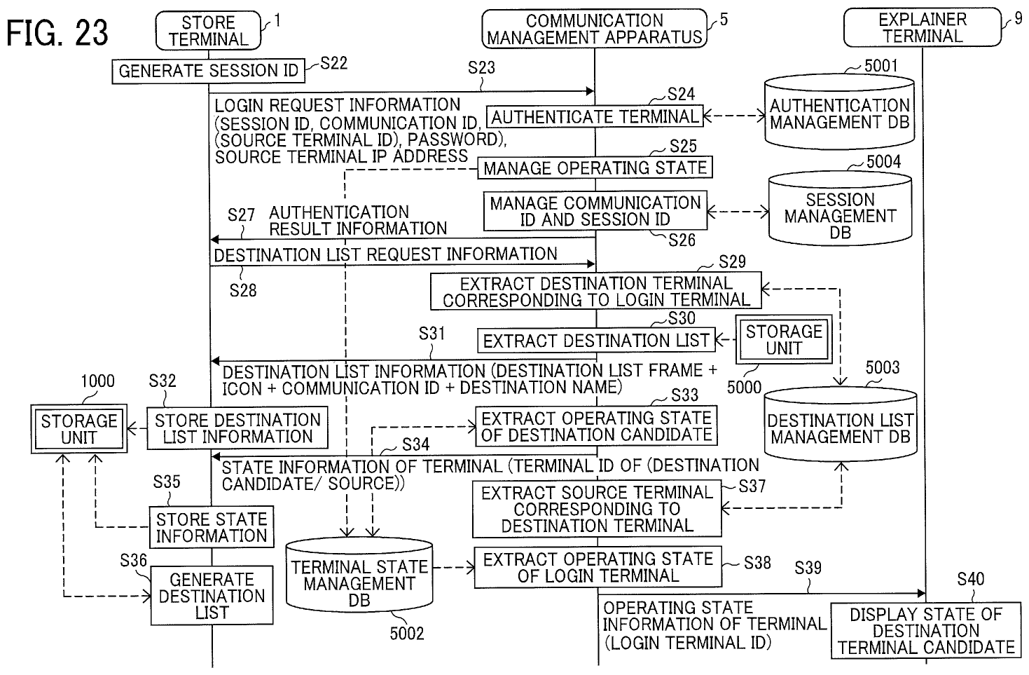

FIG. 23 is a sequence diagram illustrating an example of processing or operation of calling from the store terminal 1 to the explainer terminal 9, according to the present embodiment.

First, the creation unit 54 of the store terminal 1 creates a session ID identifying a communication session (S22). Next, the data exchange unit 11 transmits login request information indicating a login request to the communication management apparatus 5 via the communication network 100 (S23). The login request information includes the session ID created in step S22, the communication ID and the password of the store terminal 1 itself in the service information acquired in step S19. This communication ID is a source terminal ID identifying the store terminal 1 that transmits the login request in step S23.

Next, the storing/reading processing unit 59 of the communication management apparatus 5 searches the authentication management table (see FIG. 8A) using the communication ID and password included in the login request information received through the data exchange unit 51 as a search key, to perform terminal authentication by determining whether the same communication ID and the same password are stored in the authentication management table (S24). The following description is provided assuming that the storing/reading processing unit 59 determines that the same communication ID and the same password are stored in the authentication management table.

Assuming that the same communication ID and the same password are stored, and the login request is determined to be from a terminal with a legitimate usage right, in step S25, the storing/reading processing unit 59 changes the operation status in the terminal state management table (illustrated in FIG. 8B) of the terminal ID received in step S23 to “Online (ready)” and stores the reception date and time when the login request is received in step S23 in the reception date and time in the terminal management table. Thereby, in the terminal state management table, the communication ID “01 as”, the operating state “Online (ready)”, the reception date and time “2019.4.10.13:40”, and the IP address “1.2.1.4” are stored in association with each other. Note that the IP address of the terminal may be transmitted from the store terminal 1 in step S23, instead of being registered in advance.

Next, the storing/reading processing unit 59 adds a new record including the communication ID and password of the store terminal 1 received in step S23 in the session management table (see FIG. 9B) (S26). The data exchange unit 51 of the communication management apparatus 5 transmits authentication result information indicating the authentication result obtained by the process of step S24 to the store terminal 1 that has sent the login request through the communication network 100 (S27).

When the data exchange unit 11 of the login request sender terminal (store terminal 1) receives the authentication result information indicating that the store terminal has a valid usage authorization, the data exchange unit 11 transmits destination list request information indicating a request for a destination list to the communication management apparatus 5 through the communication network 100 (S28). Thereby, the data exchange unit 51 of the communication management apparatus 5 receives the destination list request infoiiiiation.

Next, the storing/reading processing unit 59 searches the destination list management table (see FIG. 9A) using the communication ID “01ab” of the login request sender terminal (store terminal 1) as a search key, to read the communication ID of the destination candidate that can communicate with the login request sender terminal (store terminal 1), and to read the destination name corresponding to the read communication ID from the terminal state management table (see FIG. 8B) (S29). As a result, the communication ID and the corresponding destination name of each of the destination candidates associated with the terminal ID “01ab” of the login request sender terminal (store terminal 1) are extracted.

Next, the storing/reading processing unit 59 of the communication management apparatus 5 reads data of a destination list frame from the storage unit 5000 (S30). Then, the data exchange unit 51 transmits destination list information (the destination list frame, the communication ID, the destination name) including the destination list frame, the communication ID and destination name read by the storing/reading processing unit 59 to the login request sender terminal (store terminal 1) (S31). Thereby, the data exchange unit 11 of the login request sender terminal (store terminal 1) receives the destination list information, and the storing/reading processing unit 19 stores the destination list information in the storage unit 1000 (S32).

As described above, in the present embodiment, the communication management apparatus 5 centrally manages the destination list information of all terminals, instead of that each terminal manages the destination list information. Accordingly, for example, when a new terminal is added to the communication system 2, when a terminal already included in the communication system is replaced with a new model, or when appearance of the destination list frame is to be changed, the communication management apparatus 5 according to the present embodiment centrally manages all destination terminal candidates, resulting in saving time and efforts for changing the destination list information by each terminal.

The storing/reading processing unit 59 of the communication management apparatus 5 searches the terminal state management table (see FIG. 8B) using the extracted communication IDs of the destination candidates as search keys, to obtain the operating states of the communication terminals as the destination candidates (S33).

The data exchange unit 51 transmits terminal state information including the communication IDs that are used as the search keys in step S26 and the operating state of the corresponding destination terminals via the communication network 100 to the source terminal (store terminal 1) (S34).

Next, the storing/reading processing unit 19 of the source terminal (store terminal 1) stores the terminal state information successively received from the communication management apparatus 5 in the storage unit 1000 (S35). The source terminal (store terminal 1) receives the state information of the above-described each terminal, and thereby acquires the current operating states of the destination candidates including the explainer terminal 9, which is currently available to communicate with the store terminal 1.

Next, the display control unit 14 of the login request sender terminal (store terminal 1) generates a destination list that reflects the states of the terminals as destination candidates based on the destination list information and the terminal state information, which are stored in the storage unit 1000 (S36). This destination list is displayed on the store terminal 1, as describe below with reference to FIG. 25C.

The storing/reading processing unit 59 of the communication management apparatus 5 searches the destination list management table (see FIG. 9A) based on the communication ID of the login request sender terminal (store terminal 1),to extract the communication ID(s) of other terminal(s) that is(are) registered in association with the communication ID of the login request sender terminal (store terminal 1) as a destination candidate (S37).

Next, the storing/reading processing unit 59 of the communication management apparatus 5 searches the terminal state management table (see FIG. 8B) based on the communication ID of the login request sender terminal (store terminal 1), to acquire the operating state of the login request sender terminal (store terminal 1) (S38).

The data exchange unit 51 transmits terminal state information including the communication ID and operating state of the login request sender terminal (store terminal 1) acquired in step S37, to the terminal(s) whose operating states is(are) “Online” in the terminal state management table (see FIG. 8B) among the terminals identified by the communication IDs extracted in step S38 (S39). When transmitting the terminal state information to the explainer terminal 9, the data exchange unit 51 refers to the IP addresses of the terminals, which are managed in the terminal state management table (see FIG. 8B), based on each communication ID. Thereby, the communication ID and the operating state of the login request sender terminal (store terminal 1) are transmitted to each of the other destination terminals that can communicate with the login request sender terminal (store terminal 1) as a destination candidate. This enables the destination candidate (such as the explainer terminal 9) to display the destination list with the operating state information as illustrated in FIG. 25C (S40).

Processes of Determining Operating State of Explainer Terminal Group:

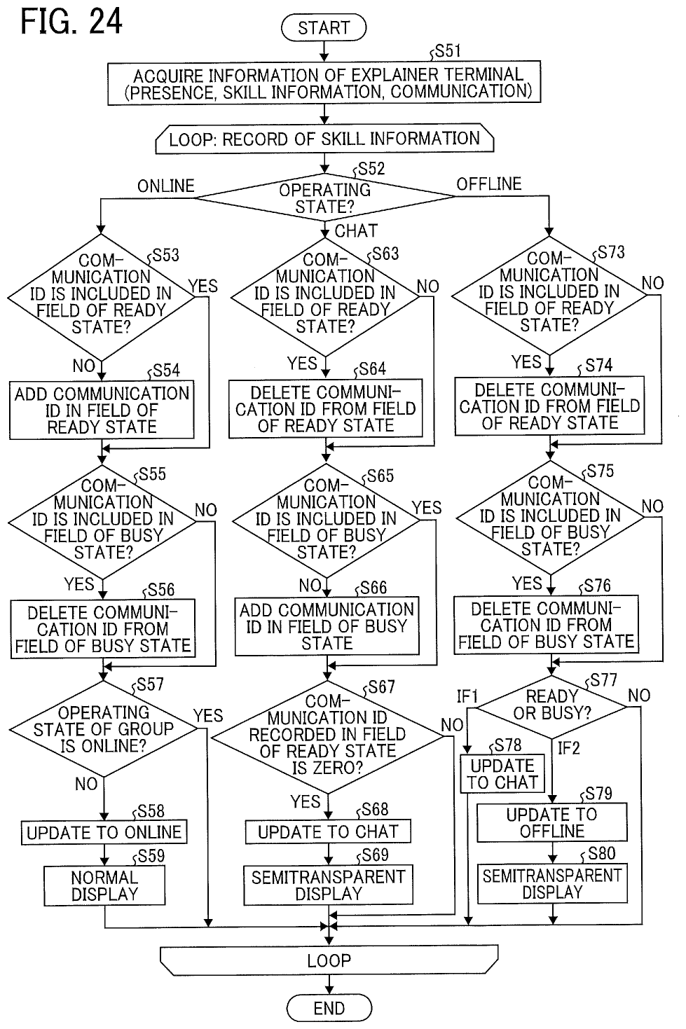

Next, processes performed by the store terminal 1 of determining the operating state of the explainer terminal group for each skill is described with reference to FIG. 24. FIG. 24 is a flowchart illustrating processes of preparing a video call by the store terminal 1, specifically processes of determining an operating state of an explainer terminal group for each skill. When the operating state of a certain skill group is “Online” it indicates that the presence of at least one destination candidate among the destination candidates of the certain skill group is “Online” indicating a state of being available for a call. When the operating state of a certain skill group is “Chat”, it indicates that none of the destination candidates of the certain skill group is in a state of “Online”, and that at least one destination candidate whose presence is “Chat” indicating a state of being chatting is included. Further, when the operating state of a certain skill group is “Offline”, it indicates that any of the destination candidates of the certain skill group are in the operating state “Offline”. A description is now given of an example of operation of determining the operating state of the skill group.

Each time when the operating state of the terminal state management table is updated in step S34 of FIG. 23, the storing/reading processing unit 19 of the store terminal 1 acquires information recorded in the updated record (S51). The acquired information includes the communication ID of the explainer terminal 9ug11, the operating state indicating the latest state of the explainer terminal 9ug11 as the destination candidate, and the skill name indicating the skill of the explainer who uses the explainer terminal 9ug11 as the destination candidate.

The storing/reading processing unit 19 of the store terminal 1 updates each record in the skill group management DB 1002 that includes the skill name acquired in step S51. For example, when the acquired skill name is “specialty 1, specialty 2”, the storing/reading processing unit 19 updates each record including the skill name “specialty 1, specialty 2” in the skill group management DB 1002.

In the following, a description is given of, as an example, an operation performed when the operating state information (operating state “Online”, skill name (specialty 1, specialty 2), communication ID “01ba”) is transmitted from the explainer terminal 9ug11 to the store terminal 1, and the store terminal 1 acquires these information items in step S51 (S52: Online).

First, a description is given of a process of updating a record including the skill name “specialty 1” in the table of the skill group management DB 1002 by loop processing. The storing/reading processing unit 19 of the store terminal 1 refers to the field of the communication ID in the state of ready in the record including the skill name “specialty 1” in the skill group management DB 1002 (see FIG. 7B). Thereby, the determination unit 15 determines whether the communication ID “01ba” acquired in step S51 is included in the field of the communication ID in the state of ready (S53).

When the determination unit 15 determines that the communication ID “01ba” acquired in step S51 is not included in the field of the communication ID in the state of ready in the skill group management DB 1002 (S53: NO), the storing/reading processing unit 19 adds the acquired communication ID “01ba” to the field of the communication ID in the state of ready (S54).

After S54 or in a case in which the determination result in S53 is YES, the storing/reading processing unit 19 of the store terminal 1 refers to the field of the communication ID in the state of busy in the record including the skill name “specialty 1” in the skill group management DB 1002 (see FIG. 7B). Thereby, the determination unit 15 determines whether the communication ID “01ba” acquired in step S51 is included in the field of the communication ID in the state of busy (S55).

When the determination unit determines that the communication ID “Olba” acquired in step S51 is included in the field of the communication ID in the state of busy in the skill group management DB 1002 (S55: YES), the acquired communication ID is deleted from the field of the communication ID in the state of busy (S56). Through the processes described so far, when the operating state of the explainer terminal 9ug11 transitions from “Chat” to “Online” or from “Offline” to “Online”, the communication ID of the explainer terminal 9ug11 is recorded only in the field of the communication ID in the state of ready in the record including the skill name “specialty 1” in the skill group management DB 1002.

After S56 or in a case in which the determination result in S55 is NO, the storing/reading processing unit 19 of the store terminal 1 refers to the operating state of the group in the record including the skill name “specialty 1” in the skill group management DB 1002 (see FIG. 7B). Thereby, the determination unit 15 determines whether the operating state of the group is “Online” (S57).

When the determination unit 15 determines that the operating state of the group in the record including the skill name “specialty 1” is recorded is not “Online” (S57: NO), the storing/reading processing unit 19 updates the operating state to “Online” (S58). Accordingly, when displaying the screen as illustrated in FIG. 25A, the display control unit 14 performs normal display so that “CRUISE”, for example, is viewed clearly (S59). By contrast, when the determination unit 15 determines that the operating state of the group in the record including the skill name “specialty 1” is “Online” (S57; YES), the storing/reading processing unit 19 does not update the operating state of the group in the recorded including the skill name “specialty 1”. Through the processes described so far, the operating state of the group in the record including the skill name “specialty 1” in the skill group management DB 1002 becomes “Online”.

Since the skill name “specialty 1, specialty 2” is acquired in step S51, the storing/reading processing unit 19 performs the loop processing for each record including the skill name “specialty 2” in the skill group management DB 1002 to update the record, in substantially the same manner as described above.

In the following, a description is given of, as an example, an operation performed when the operating state information (operating state “Chat”, skill name (specialty 1, specialty 2), communication ID “01ba”) is transmitted from the explainer terminal 9ug11 to the store terminal 1, and the store terminal 1 acquires these information items in step S51 (S52: Chat).

First, a description is given of a process of updating a record including the skill name “specialty 1” in the table of the skill group management DB 1002 by loop processing. The storing/reading processing unit 19 of the store terminal 1 refers to the field of the communication ID in the state of ready in the record including the skill name “specialty 1” in the table of the skill group management DB 1002. Thereby, the determination unit 15 determines whether the communication ID “01ba” acquired in step S51 is included in the field of the communication ID in the state of ready (S63).

When the determination unit determines that the communication ID “01ba” acquired in step S51 is included in the field of the communication ID in the state of ready in the skill group management DB 1002 (S63: YES), the storing/reading processing unit 19 deletes the acquired communication ID “01ba” from the field of the communication ID in the state of ready (S64).

After S64 or in a case in which the determination result in S63 is NO, the storing/reading processing unit 19 of the store terminal 1 refers to the field of the communication ID in the state of busy in the record including the skill name “specialty 1” in the skill group management DB 1002. Thereby, the determination unit 15 determines whether the communication ID “01ba” acquired in step S51 is included in the field of the communication ID “01ba” in the state of busy (S65).

When the determination unit 15 determines that the communication ID “01ba” acquired in step S51 is not included in the field of the communication ID in the state of busy in the skill group management DB 1002 (S65: NO), the acquired communication ID “01ba” is added to the field of the communication ID in the state of busy (S66). Through the processes described so far, the communication ID of the explainer terminal 9ug11 is recorded only in the field of the communication ID in the state of busy in the record including the skill name “specialty 1” in the skill group management DB 1002.

After S66 or in a case in which the determination result in S65 is YES, the storing/reading processing unit 19 of the store terminal 1 refers to the field of the communication ID in the state of ready in the record including the skill name “specialty 1” in the skill group management DB 1002. Thereby, the storing/reading processing unit 19 determines whether the number of communication IDs recorded in the field of the communication ID in the state of ready in the record including the skill name “specialty 1” is recorded is zero (S67).

When the number of communication IDs recorded in field of the communication ID in the state of ready in the record including the skill name “specialty 1” is zero (S67: YES), the storing/reading processing unit 19 updates the operating state of the group in the record including the skill name “specialty 1” to “Chat” (step S68). Thus, when displaying the screen as illustrated in FIG. 25A, the display control unit 14 performs semitransparent display such as “WEDDING” (S69). By contrast, when the number of communication IDs recorded in the field of communication ID in the state of ready in the record including the skill name “specialty 1” is not zero (S67: NO), the storing/reading processing unit 19 does not update the operating state of the group in the record including the skill name “specialty 1”. In other words, when the communication ID is recorded in the field of communication ID in the state of ready in the record including the skill name “specialty 1”, a corresponding operating state remains as “Online” without being updated.

Since the skill name “specialty 1, specialty 2” is acquired in step S51, the storing/reading processing unit 19 performs the loop processing for each record including the skill name “specialty 2” in the skill group management DB 1002 to update the record, in substantially the same manner as described above.

In the following, a description is given of, as an example, an operation performed when the operating state information (operating state “Offline”, skill name (specialty 3, specialty 4), communication ID “01ca”) is transmitted from the explainer terminal 9ug21 to the store terminal 1, and the store terminal 1 acquires these infoimation items in step S51 (S52: Offline).

First, a description is given of a process of updating a record including the skill name “specialty 3” in the skill group management DB 1002 by loop processing. The storing/reading processing unit 19 of the store terminal 1 refers to the field of the communication ID in the state of ready in the record including the skill name “specialty 3” in the table stored in the skill group management DB 1002. Thereby, the determination unit 15 determines whether the communication ID “01ca” acquired in step S51 is included in the field of the communication ID in the state of ready (S73).

When the determination unit 15 determines that the communication ID “01ca” acquired in step S51 is included in the field of the communication ID in the state of ready in the skill group management DB 1002 (S73: YES), the storing/reading processing unit 19 deletes the acquired communication ID “01ca” from the field of the communication ID in the state of ready (S74).

After S74 or in a case in which the determination result in S73 is NO, the storing/reading processing unit 19 of the store terminal 1 refers to the field of the communication ID in the state of busy in the record including the skill name “specialty 3” in the table stored in the skill group management DB 1002. Thereby, the determination unit 15 determines whether the communication ID “01ca” acquired in step S51 is included in the field of the communication ID in the state of busy (S75).

When the determination unit 15 determines that the communication ID “01ca” acquired in step S51 is included in the field of the communication ID in the state of busy in the skill group management DB 1002 (S75: YES), the acquired communication ID “01ca” is deleted from the field of the communication ID in the state of busy (S76). Through the processes described so far, the communication ID of the explainer terminal 9ug21 is deleted from the record including the skill name “specialty 3” in the skill group management DB 1002.

After S76 or in a case in which the determination result in S75 is NO, the storing/reading processing unit 19 of the store terminal 1 refers to the fields of the communication ID in the state of ready and in the state of busy in the records including the skill name “specialty 3” in the skill group management DB 1002. Thus, the storing/reading processing unit 19 determines whether a condition IF1 or a condition IF2 is satisfied (step S77). The condition IF1 is satisfied when the number of communication IDs listed in the field of the communication ID in the state of ready in the record including the skill name “specialty 3” is zero and the number of communication IDs listed in the field of the communication ID in the state of busy is not zero. The condition IF2 is satisfied when the number of communication IDs included in the field of communication ID in the state of ready in the record including the skill name “specialty 3” is zero and the number of communication IDs included in the field of communication ID in the state of busy is zero.

When the number of the communication IDs recorded in the field of communication ID in the state of ready in the record including the skill name “specialty 3” is zero and the number of the communication IDs recorded in the field of communication ID in the state of busy in the same record is not zero (S77: IF1), the storing/reading processing unit 19 updates the operating state of the group in the record including the skill name “specialty 3” to “Chat” in skill group management DB 1002 (step S78). When the number of the communication IDs included in the field of the communication ID in the state of ready in the record including the skill name “specialty 3” is zero and the number of the communication IDs included in the field of communication ID in the state of busy in the same record is zero (S77: IF2), the storing/reading processing unit 19 updates the operating state of the group in the record including the skill name “specialty 3” to “offline” in the skill group management DB 1002 (S79).

Thus, when displaying the screen as illustrated in FIG. 25A, the display control unit 14 performs semitransparent display such as “WEDDING” (S80). By contrast, when the determination of S77 is not either IF1 or IF2 (S77: NO), the storing/reading processing unit 19 does not update the operating state of the group in the record including the skill name “specialty 3”, i.e., keeps the operating state as being “online”.

Since the skill name “specialty 3, specialty 4” is acquired in step S51, the storing/reading processing unit 19 performs the loop processing for each record including the skill name “specialty 4” in the skill group management DB 1002 to update the record, in substantially the same manner as described above.

Processes of Starting Video Call:

Next, with reference to FIG. 25 (FIG. 25A to FIG. 25D) and FIG. 26, operation of starting a video call for a remote customer service is described. FIGS. 25A to 25D are diagrams each illustrating a screen displayed on the store terminal 1. FIG. 26 is a sequence diagram illustrating operation of starting a video call.

The display control unit 14 of the store terminal 1 controls the display 106 of the store terminal 1 to display any one of the screens of FIGS. 25A to 25D, and the reception unit 12 receives selection of a desired skill group or designation of a desired explainer from a customer (S82).

Specifically, the storing/reading processing unit 19 acquires sets of the skill name and the operating state of the skill group associated with the skill name stored in the table of the skill group management DB 1002 (see FIG. 7B). Thereby, the display control unit 14 controls the display 106 of the store terminal 1 to display a skill selection screen as illustrated in FIG. 25A.

In the right half area of the skill selection screen, skill display buttons (cruise, wedding, etc.) that allows the customer to select a desired skill, and an explainer list display button that, when selected, displays a destination list of all the explainer are displayed. In the example of FIG. 25A, the skill display button of “CRUISE” is normally displayed, to allow the customer to select this button. By contrast, the skill display button of “WEDDING” is semi-transparently displayed, whereby not allowing the customer to select this button. For example, when the customer selects the skill display button of “CRUISE”, the reception unit 12 receives the selection, and thereby the display control unit 14 controls the display 106 to display a confirmation screen as illustrated in FIG. 25B. When the customer presses of the “OK” button on the confirmation screen, the reception unit 12 receives the pressing. the data exchange unit 11 transmits connection request information indicating a connection request of a communication session for a video call to a desired explainer terminal 9 via a communication management apparatus 5 (see S84-1 and S85-1 described below).

On the other hand, when the customer selects the explainer list display button on the skill selection screen illustrated in FIG. 25A, the reception unit 12 receives the selection, and thereby the display control unit 14 controls the display 106 to display an explainer destination list as illustrated in FIG. 25C based on the explainer name, the operating state of the explainer terminal, and the skill name stored in the table of the explainer management DB 1001 (see FIG. 7A). On the screen as illustrated in FIG. 25C, the customer selects a name of a desired explainer who uses the explainer terminal from the explainer terminals in the state of ready, and presses the “OK” button. In response to such customer's operation, the reception unit 12 receives the designation of the desired explainer, and the display control unit 14 controls the display 106 to display a confirmation screen as illustrated in FIG. 25D. When the customer presses of the “OK” button on the confirmation screen, the reception unit 12 receives the pressing. In response to receiving the pressing by the reception unit 12, the data exchange unit 11 transmits a start request of a video call to the explainer terminal 9 that is designated via the communication management apparatus 5 (see the process of S90 and processes of FIG. 27 described below).

Subsequently, when the customer selects, by using the store terminal 1, a desired skill group (for example, the support organization capable of providing consultation about a cruise) on the skill selection screen of FIG. 25A, the determination unit 15 of the store terminal 1 deteimines whether to transmit the start request of the video call to the explainer terminal in the state of “Online (ready)” belonging to a particular skill group (for example, cruise) of the unmanned store priority support organization UG1, or to transmit the start request of the video call to the explainer terminal in the state of “Online (ready)” in the same particular skill group (for example, cruise) of the manned store priority support organization MG1 (S83). In this determination process, the store terminal 1 makes the determination based on the subgroup name to which the account ID of the store terminal itself belongs in the subgroup management table (see FIG. 13B) in the service information received in step S19. When the store terminal 1 itself belongs to the unmanned store, the determination unit 15 sets a destination of the start request to the particular skill group of the unmanned store priority support organization UG1. By contrast, when the store terminal 1 itself belongs to the manned store, the determination unit 15 sets the destination of the start request to the particular skill group of the manned store priority support organization MG1.

In the following, a description is given of a case in which when the store terminal 1 is the store terminal 1c2 in FIG. 1 provided in the unmanned store US, the start request of the video call is preferentially transmitted (first transmission) to the explainer terminal 9ug11 and the explainer terminal 9ug12, each being in the state of “Online (ready)”, of the support organization SR21 for the skill SK1 of the unmanned store priority support organization UG1.

First, the data exchange unit 11 of the store teiniinal 1c2 simultaneously transmits connection request information indicating a connection request of a communication session for the video call as a first time transmission, as a previous step of a start request of the video call (see S101 in FIG. 27) (S84-1). This connection request information includes the communication ID(s) associated with the operating state “Online” among the communication IDs read in step S 83, the communication ID of the store terminal 1c2 that is the start request sender terminal, and the skill name indicating the skill selected in step S82.

Next, in response to receiving the connection request information transmitted by the store terminal 1c2, the data exchange unit 51 of the communication management apparatus 5 transmits the start request of this video communication to the explainer terminal 9ug11 identified by the communication ID included in the received connection request information (step S 84-2).

When the operating state is updated in step S34 (see FIG. 23) between a time when the store terminal 1c2 transmits the connection request information and a time when the store terminal 1c2 receives a response to the connection request information, the store terminal 1c2 repeats the processes of steps S82 and S83. When the operating state of the explainer terminal 9 is updated to “Online” and the communication ID is extracted as the communication ID associated with the operating state “Online” as a result of the above process, The data exchange unit 11 of the store terminal 1c2 transmits the connection request information including the communication ID to the communication management apparatus 5 (step S85-1). The connection request information transmitted in step S85-1 also includes the skill name indicating the skill selected in step S82 and the communication ID of the store terminal 1c2 itself.

In response to receiving the connection request information transmitted by the store terminal 1, the data exchange unit 51 of the communication management apparatus 5 transmits the connection request information to the explainer terminal 9ug12 identified by the communication ID included in the received connection request information (step S85-2).

Each of the data exchange unit 91 of the explainer terminal 9ug11 and the data exchange unit 91 of the explainer terminal 9ug12 receives the connection request information transmitted from the store terminal 1c2 via the communication management apparatus 5. In response to receiving the connection request information, the display control unit 94 of the explainer terminal 9ug11 and the display control unit 94 of the explainer terminal 9ug12 respectively controls the display 106 of the explainer terminal 9ug11 and the display 106 of the explainer terminal 9ug12 to display a message including information on the request sender terminal corresponding to the communication ID included in the connection request information and the skill name (skill information) corresponding to the skill name included in the call start request. Since the message includes the skill, the explainer of each explainer terminal 9ug11 and the explainer terminal 9ug12 recognizes in advance what travel product the customer desires.

Next, when each of the explainer ug11 using the explainer terminal 9ug11 and the explainer ug12 using the explainer terminal 9ug12 performs an input operation of permitting a response, each of the reception unit 92 of the explainer terminal 9ug11 and the reception unit 92 of the explainer terminal 9ug12 receives the input operation of permitting the response (steps S86-1 and S86-2). In response to receiving the input operation of permitting the response, each of the data exchange unit 91 of the explainer terminal 9ug11 and the data exchange unit 91 of the explainer terminal 9ug12 transmits response information indicating that connection is permitted to the communication management apparatus 5 (steps S87-1 and S88-1).

This response information includes the communication ID of the transmission source (the store terminal 1c2) and the communication ID of the explainer terminal itself (9ug11, 9ug12). Thus, the data exchange unit 51 of the communication management apparatus 5 receives the response information transmitted by each of the explainer terminal 9ug11 and the explainer terminal 9ug12. Note that the above process is just an example. In another example, in response to receiving the connection request information from the store terminal 1c2, each of the data exchange unit 91 of the explainer terminal 9ug11 and the data exchange unit 91 of the explainer terminal 9ug12 automatically transmits the response information to the connection request to the store terminal 1c2. In still another example, in a case in which each of the data exchange unit 11 of the explainer terminal 9ug11 and the data exchange unit 91 of the explainer terminal 9ug12 receives a plurality of pieces of connection request information from a plurality of store terminals 1, the data exchange unit 91 transmits the response information to the store terminal 1 from which the connection request information is received first.

Next, the data exchange unit 51 of the communication management apparatus 5 transmits the received response information to the store terminal 1c2 identified by the communication ID included in this response information (steps S87-2, S88-2). In a case in which the data exchange unit 11 of the store terminal 1c2 receives a plurality of pieces of response information, the determination unit 15 identifies the explainer terminal 9 that transmits the response information earliest (S89). In the present embodiment, a description is given hereinafter of an example case in which the explainer terminal 9ug11 first transmits the response information.

The data exchange unit 51 of the communication management apparatus 5 controls establishment of a communication session for performing a video call between the explainer terminal 9ug11 and the store terminal 1, which are respectively identified by the “communication ID of the store terminal” and the “communication ID of the explainer” included in the communication establishment request. Through the established session, content data such as image data or audio data is exchanged between the explainer terminal 9ug11 and the store terminal 1 via the relay apparatus 3 (step S90). A detailed description is given of the step S90 below with reference to FIG. 27. The session described above is an example and not limiting. In another example, in the session, the content data is directly exchanged between the explainer terminal 9ug11 and the store terminal 1c2 through the communication network 100. Once the communication is established between the store terminal 1c2 and the explainer terminal 9ug11, one of the store terminal 1a and the explainer terminal 9ug11 transmits image data of an image captured by the own terminal and audio data of sound collected by the own terminal to the other one of the store terminal 1c2 and the explainer terminal 9ug11 via the relay apparatus 3. Thus, video call can be started between the customer and the explainer, as illustrated in FIG. 2.

When the communication is established in step S90, the data exchange unit 91 of the explainer terminal 9ug11 transmits the state information including the operating state “Chat”, the skill name “specialty 1”, and the communication ID of the explainer terminal 9ug11 to the communication management apparatus 5.

Further, when the communication is established in step S90, the data exchange unit 11 of the store terminal 1c2 transmits cancellation information to the communication management apparatus 5, to cancel the call start requests from the explainer terminals 9 that transmit the response information, except for the explainer terminal 9 from which the store terminal 1c2 receives the response information first.(S91-1). The cancellation information includes the communication ID of the store terminal 1c2 itself and the communication ID of the explainer terminal 9 (in this example, the explainer terminal 9ug12) that transmit the response information, except for the explainer terminal from which the store terminal 1c2 receives the response information first.

In response to receiving the cancellation information, the data exchange unit 51 of the communication management apparatus 5 transmits the cancellation information to the explainer terminal 9ug12 identified by the communication ID included in the cancellation information (step S91-2). The data exchange unit 11 of the explainer terminal 9ug12 receives the cancellation information transmitted by the communication management apparatus 5. This allows the explainer terminal 9ug12 to be informed that the response is not necessary any more to the call start request from the store terminal 1.

Processes of Establishing Communication:

A detailed description is now given of processes of controlling establishment of the session performed in S90 of FIG. 26, with reference to FIG. 27. FIG. 27 is a sequence diagram illustrating detailed processes of controlling establishment of the session.

First, the store terminal 1c2 transmits start request information indicating a request for start a video call to the communication management apparatus 5 (step S101). The start request information includes the communication ID of the source terminal (in this example, the store terminal 1c2) and the communication ID of the explainer ug11 of the destination terminal (in this example, the explainer terminal 9ug11). Thereby, the communication management apparatus 5 receives the start request information.

Next, the selection unit 53 of the communication management apparatus 5 selects the nearest relay apparatus based on the IP addresses of the source terminal and the destination terminal (step S102). The IP address of each terminal is stored in the terminal management table, and the IP address of each relay apparatus is stored in the storage unit 5000 in advance.

Next, the creation unit 54 creates communication information including the IP address of the relay apparatus 3 and the communication IDs described above (step S103). Next, the storing/reading processing unit 59 stores, in the communication information management DB 5005 (see FIG. 9C), the communication IDs and the IP address of the relay apparatus 3, which is contents of the communication information, and the communication IDs of the source terminal and the explainer of the destination terminal received in step S101, in association with each other (S104). After that, the data exchange unit 51 transmits start request information to the destination terminal (in this example, the explainer terminal 9ug11) (step S105). The start request information includes the communication information in addition to the communication IDs transmitted from the source terminal in step S101. Thereby, the data exchange unit 91 of the destination terminal receives the start request information.

Next, the determination unit 95 of the explainer terminal 9ug11 as the destination terminal determines whether the communication ID of the source terminal (the store terminal 1c2) received in S105 is the same communication ID of the store terminal 1c2, which has already been received in the process of step S84-2 in FIG. 26 (S106). In this case, since the communication IDs are the same with each other, the data exchange unit 91 transmits response approval information to the communication management apparatus 5 (step S107). The response approval information in this case indicates that a response is available and includes the communication ID of the source terminal. Thereby, the data exchange unit 51 of the communication management apparatus 5 receives the response approval information.

Next, the storing/reading processing unit 59 of the communication management apparatus 5 searches the communication information management DB 5005 using the communication ID of the source terminal received in step S107 as a search key, to read the associated communication information (the communication ID, the IP address of the relay apparatus 3) (step S108).

Next, the data exchange unit 51 transmits the response approval information to the source terminal (S109). This response approval information includes the communication information read in step S108. Thereby, the data exchange unit 11 of the source terminal receives the response approval information.

Next, the data exchange unit 91 of the destination terminal transmits establishment request information indicating a request for establishing a mutual communication session to the IP address of the relay apparatus 3 included in the communication information received in step S105 (step S110). This establishment request information includes the communication ID of the source terminal and the communication ID of the explainer of the destination terminal. The establishment request information further includes the IP address of the destination terminal, which is a sender terminal of the establishment request information.

On the other hand, the data exchange unit 11 of the source terminal transmits establishment request information indicating a request for establishing a mutual communication session to the IP address of the relay apparatus 3 included in the communication information received in step S109 (step S111). This establishment request information includes the communication ID of the source terminal and the communication ID of the explainer of the destination terminal. The establishment request infoimation further includes the IP address of the source terminal, which is a sender terminal of the establishment request information. Thus, a communication session for mutual communication of images and sounds is established between the relay apparatus 3 and the source terminal (step S112-1). Further, a communication session for mutual communication of images and sounds is established between the relay apparatus 3 and the destination terminal (step S112-2).

Next, the data exchange unit 11 of the source terminal transmits state information of the source terminal itself to the communication management apparatus 5 (step S113-1). The state information includes the communication ID of the starting teiiiiinal and the operating statue information (in this example “Chat (busy)”). Thereby, the data exchange unit 51 of the communication management apparatus 5 receives the state information of the source terminal. On the other hand, the data exchange unit 91 of the destination terminal transmits state information of the destination terminal itself to the communication management apparatus 5 (step S113-2). The state information includes the communication ID of the destination terminal and the operating statue information (in this example, “Chat (busy)”).

Thereby, the data exchange unit 51 of the communication management apparatus 5 receives the state infoiiiiation of the destination terminal. As described, each terminal transmits a notification indicating the operating state of the own terminal to the communication management apparatus 5. The storing/reading processing unit 59 of the communication management apparatus 5 changes the operating state associated with the communication ID of the source terminal to “Chat (busy)” in the terminal management table (see FIG. 12), and changes the operating state associated with the communication ID of the destination terminal to “Chat (busy)” (step S114). Thus, the source terminal (store terminal 1c2) and the destination terminal (explainer terminal 9ug11) performs a video call by mutual communication, as illustrated in FIG. 2. The description given heretofore is of the processes performed when the skill group such as “cruise” is selected on the screen as illustrated FIG. 25A in step S82.

Start Request of Video Call when Particular Explainer is Designated:

A description is now given of processes of starting video call when a particular explainer is designated on the screen as illustrated in FIG. 25C in step S82. In this case, only the process of step S90 in FIG. 26 is performed among the processes of step S84 and subsequent steps.

Further, since the processes of steps S84-2 and S85-2 of FIG. 26 are not performed when a particular explainer is designated, in step S106 of FIG. 27, the display control unit 94 displays the communication ID of the source terminal, so that the designated explainer manually selects whether or not to respond. When the designated explainer selects whether to respond, the reception unit 92 receives the selection of whether to respond.

In steps S107 and S109, response approval or denial information is transmitted instead of the response approval information. The response approval or denial information also includes the communication ID of the source terminal. Other processes are performed in the same or substantially the same manner as when the skill group is selected, and therefore the redundant descriptions thereof are omitted below.

Processes of Changing Destination to which Start Request of Video Call is to be Transmitted:

A description is now given of processes changing a destination to which the start request of the video call is to be transmitted, the processes being performed when no explainer terminal responds to the start request in steps S86-1 and S86-2 of FIG. 26, with reference to FIG. 28. FIG. 28 is a flowchart illustrating various types of processes of starting a call. Specifically, FIG. 28 is a flowchart illustrating three patterns of the start request after selecting a desired skill group, a change of the transmission destination to which the start request is to be transmitted, and the start request when a desired explainer is designated.

Note that deteiniinations by the determination unit 15 described below are performed based on each information managed in the explainer management DB 1001 and the skill group management DB 1002 stored in the storage unit 1000.

First, the store terminal 1c2 in the unmanned store US, the determination unit 15 determines whether a desired skill group is selected or a desired explainer is designated in step S82 of FIG. 26 (S201).

When the desired skill group is selected (S201: skill), the determination unit 15 determines whether any explainer terminal whose operating state is “Online (ready)” belonging to the unmanned store priority support organization is present for the selected skill group in the same area E1 (S202). When one or more explainer terminals whose operating states are “Online (ready)” belonging to the unmanned store priority support organization are present (S202; YES), the data exchange unit 11 of the store terminal 1c2 simultaneously transmits as the first time, to the one or more explainer terminals whose operating states are

“Online (ready)” belonging to the unmanned store priority support organization, connection request information indicating a connection request of a communication session for the video call, as a previous step of the start request of the video call (see S101 of FIG. 27) (S203). The process of step S203 corresponds to the processes of steps S84-1 and S85-1 in FIG. 26.

After the processes of steps S84-1 and S85-1, the determination unit 15 determines whether the store terminal 1c2 receives the response information from each of the explainer terminal 9ug11 and the explainer terminal 9ug12 within a certain time period (e.g., 30 seconds) (S87-2 and S88-2) (S204). When the response information is received within the certain time period (S204; YES), the store terminal 1c2 performs control of establishing communication with the explainer terminal (in this example, the explainer terminal 9ug11) that responds first (S205). The process of step S205 corresponds to the processes of steps S89 and S90 in FIG. 26. In this case, the operation of FIG. 28 ends.

By contrast, when the response information indicating connection is unavailable is received (S202: NO), or when the response information indicating whether or not the connection is available is not received within the certain time period (e.g., 30 seconds) after the connection request information is transmitted in (S204: NO), The data exchange unit 11 of the store terminal 1c2 changes the destination to the explainer terminal 9mg11 and the 9mg12 whose operating states are “Online (ready)” belonging to the manned store priority support organization, to transmit the connection request information as the second time to the changed destination (S206). After the processes of steps S84-1 and S85-1 as the second time, the determination unit 15 determines whether the store terminal 1c2 receives the response infotmation (S87-2, S88-2) from each of the explainer terminal 9mg11 and the explainer terminal 9mg12 within a certain time period (S207). When the response information is received within the certain time period (S207: YES), the store terminal 1c2 performs control of establishing communication with the explainer terminal (in this example, the explainer terminal 9mg11) that responds in step S205. By contrast, when no response information is received within the certain time period (S207: NO), the display control unit 14 controls the display 106 of the store terminal 1c2 itself to display an error dialog box indicating that no response is received (S208). Then, the operation returns to step S201.

On the other hand, when a desired explainer is designated in S201 (S201: designation), the display control unit 14 controls the display 106 of the store terminal 1c2 itself to display the destination list of the explainer as illustrated in FIG. 25C (S209). The reception unit 12 receives the designation (selection) of the explainer from the customer c2 (S210). The processes of steps S209 and S210 corresponds to the processes of step S82 in FIG. 26.

Accordingly, the store terminal 1c2 performs control of establishing communication only with the designated explainer terminal (in this example, the explainer terminal 9ug11) (S211). The process of step S211 corresponds to the process of step S90 in FIG. 26.

Flow of Bidirectional Writing:

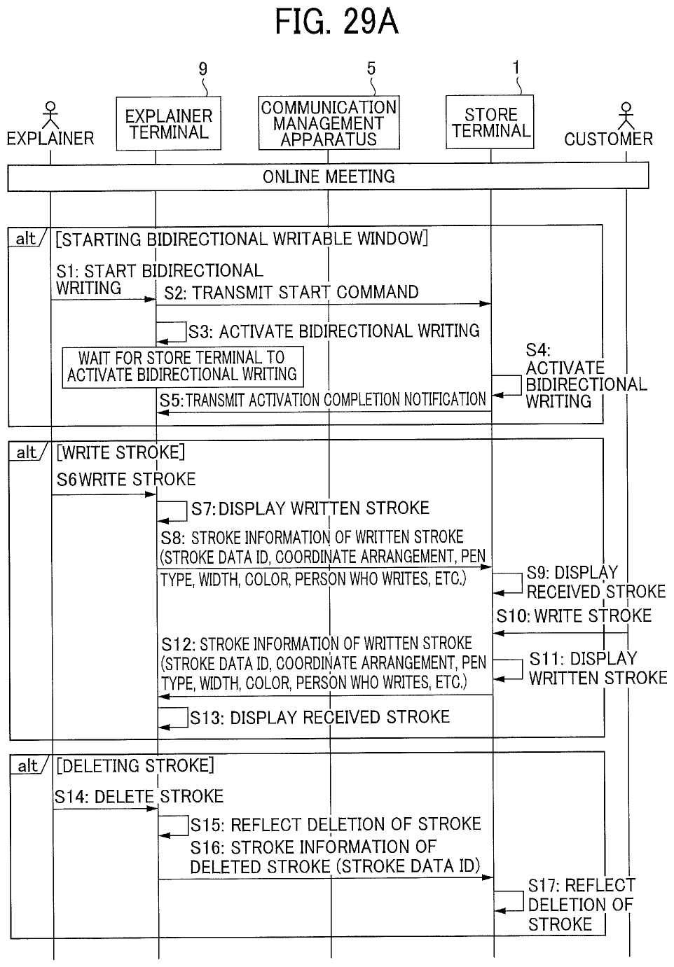

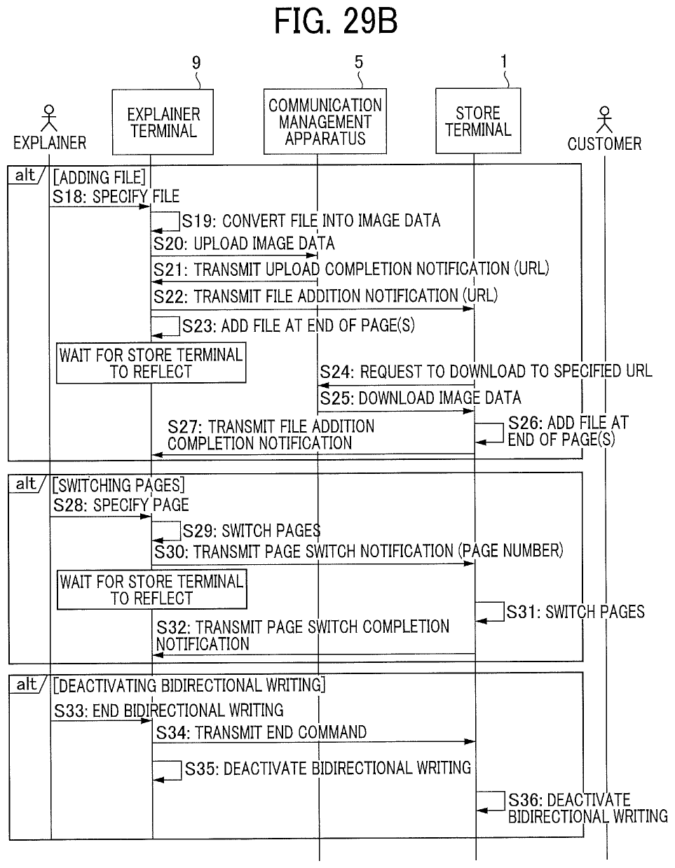

A description is given below of processing or operation of performing bidirectional writing with respect to a document (writable window) by a customer and an explainer performed by the communication system 2 after a session is established, with reference to FIG. 29A and FIG. 29B. FIG. 29A and FIG. 29B are sequence diagrams each illustrating processing or operation performed by the communication system 2 when the customer and the explainer bidirectionally write on the document, according to the present embodiment.

When communicating, each of the store terminal 1 and the explainer terminal 9 attaches the own communication ID, which is not clearly illustrated in FIG. 29A and FIG. 29B though. This is because the store terminal 1 and the explainer terminal 9 notify the communication management apparatus 5 and the relay apparatus 3 of the session and the like. Although communications are performed via the communication management apparatus 5 or the relay apparatus 3 in the communication system 2, a description of the steps in which the communications pass through the communication management apparatus 5 or the relay apparatus 3 is omitted below. The communication management apparatus 5 refers to the session management table based on a communication ID transmitted from a data transmission source, and identifies the explainer terminal 9 or the store terminal 1 corresponding to a data transmission destination. The relay apparatus 3 refers to the session management table based on the communication ID transmitted from a data transmission source, and identifies the explainer terminal 9 or the store terminal 1 corresponding to a data transmission destination.

A description is given below of processing of activation of a bidirectional writing function.

S1: When the customer writes to fill in the application form, the explainer performs an operation to activate the bidirectional writing function. The reception unit 12 of the explainer terminal 9 accepts the operation.

S2: The data exchange unit 91 of the explainer terminal 9 transmits a start (activation) command for the bidirectional writing function to the store terminal 1. The bidirectional writing function is implemented by a single application or module, for example.

S3: The bidirectional writing function is activated in the explainer terminal 9. As a result, the write processing unit 96, the menu display unit 97, and the file display unit 98 of the explainer terminal 9 are enabled.

S4: The data exchange unit 11 of the store terminal 1 activates the bidirectional writing function by receiving the start command for the bidirectional writing function. As a result, the write processing unit 16, the menu display unit 17, and the file display unit 18 of the store terminal 1 are enabled. After that, the explainer terminal 9 waits for the store terminal 1 to start up or activate the bidirectional writing function. Since the strokes are synchronized between the store terminal 1 and the explainer terminal 9, the handwritten strokes are not able to be input by the explainer unless the bidirectional writing function is activated in the store terminal 1.

S5: When the activation of the bidirectional writing function of the store terminal 1 is completed, the data exchange unit 11 transmits an activation completion notification to the explainer terminal 9.

When the bidirectional writing function is activated, a writable window is displayed on each of the explainer terminal 9 and the store terminal 1. Immediately after the bidirectional writing function is activated, a default whiteboard is displayed on the writable window. Alternatively, the document of the URL described in the setting file, which is referred by the explainer terminal 9 at the time of the activation, is displayed (file display units 18 and 98 display the document based on the URL). The write processing unit 16 of the store terminal 1 and the write processing unit 96 of the explainer terminal 9 accept write operations.

A description is given below of processing of writing a stroke performed by the explainer or the customer. S6: The explainer writes a stroke on the explainer terminal 9 with a pen or a fingertip, for example. The write processing unit 96 of the explainer terminal 9 accepts the write operation.

S7: The write processing unit 96 of the explainer terminal 9 displays the stroke on the writable window.

S8: The write processing unit 96 stores the stroke data in the stroke data management DB 9003 of the explainer terminal 9. Further, the write processing unit 96 transmits the stroke data to the store terminal 1 via the data exchange unit 91 for synchronization. The stroke data is also stored in the communication management apparatus 5.

S9: The data exchange unit 11 of the store terminal 1 receives the stroke data, and the write processing unit 16 of the store terminal 1 stores the stroke data in the stroke data management DB 1003 of the store temiinal 1. Further, the write processing unit 16 of the store terminal 1 displays the stroke data on the writable window.

S10: the customer using the store terminal 1 is also able to input handwritten strokes as long as the explainer does not restrict the operation. The write processing unit 16 of the store terminal 1 accepts the write operations.

S11: The write processing unit 16 of the store terminal 1 displays the stroke data on the writable window.

S12: The write processing unit 16 of the store terminal 1 transmits the stroke data to the explainer terminal 9 via the data exchange unit 11 for synchronization. The stroke data is also stored in the communication management apparatus 5.

S13: The data exchange unit 91 of the explainer terminal 9 receives the stroke data, and the write processing unit 96 of the explainer terminal 9 stores the stroke data in the stroke data management DB 9003 of the explainer terminal 9. Further, the write processing unit 96 of the explainer terminal 9 displays the received stroke data on the writable window.

As described above, the explainer and the customer bidirectionally write with respect to the same document.

A description is given below of processing of deleting a stroke performed by the explainer or the customer. S14: The explainer performs an operation of deleting a stroke that is previously written. The stroke to be deleted may be written by either the explainer or the customer. The write processing unit 96 of the explainer terminal 9 accepts the delete operation.

S15: The write processing unit 96 of the explainer terminal 9 deletes the stroke of which the deletion (delete operation) has been accepted through the writable window.

S16: The write processing unit 96 deletes the stroke data, which represents the stroke deleted, from the stroke data management DB 9003 of the explainer terminal 9. Further, the write processing unit 96 notifies the store terminal 1 of the deleted stroke data ID via the data exchange unit 91 for synchronization. The deletion of the stroke data is also received by the communication management apparatus 5 and reflected in the stroke data management DB 5006.

S17: The data exchange unit 11 of the store terminal 1 receives the deleted stroke data ID, and the write processing unit 16 of the store terminal 1 reflects the deletion of the corresponding stroke in the stroke data management DB 1003 of the store terminal 1. Further, the write processing unit 16 of the store terminal 1 deletes the stroke data identified by the stroke data ID from the writable window.

Although not clearly illustrated in the figure, the deletion of a stroke is also performable from both directions of the explainer terminal 9 and the store terminal 1.

A description is given below of processing of adding a file performed by the explainer. Adding a file means enabling the store terminal 1 and the explainer terminal 9 to display documents such as an application form and a pamphlet on the writable window. In the present embodiment, the explainer terminal 9 adds the file.

S18: The explainer performs an operation to specify the file to be displayed on the writable window. The reception unit 92 of the explainer terminal 9 accepts the specifying operation.

S19: The file display unit 98 of the explainer terminal 9 converts the file into image data for each page. Because the file is converted to the image data, the explainer terminal 9 and the store terminal 1 do not have to activate an application that is compatible with the file. However, the explainer terminal 9 may upload the file as it is without converting.

S20: The data exchange unit 91 of the explainer terminal 9 uploads the image data for each page to the communication management apparatus 5. The upload destination may be a server capable of storing the image data, and is not limited to the communication management apparatus 5.

S21: The data exchange unit 91 of the explainer terminal 9 receives an upload completion notification along with an URL that is the image data storage destination.

S22: The data exchange unit 91 of the explainer terminal 9 transmits the URL of the image data storage destination to the store terminal 1.

S23: The file display unit 98 of the explainer terminal 9 adds to the pages, which are already registered on the writable window, the image data for each page as a page at the end of the pages. After that, the explainer terminal 9 waits until the store terminal 1 downloads the image data. This is because the same document is not to be displayed unless both the explainer terminal 9 and the store terminal 1 holds, or stores, the image data.

S24: When receiving the URL of the image data storage destination, the data exchange unit 11 of the store terminal 1 requests to download the file to the URL of the image data storage destination.

S25: The data exchange unit 11 of the store terminal 1 receives the image data for each page.

S26: The file display unit 18 of the store terminal 1 adds to the pages, which are already registered on the writable window, the image data for each page as a page at the end of the pages.

S27: The data exchange unit 11 of the store terminal 1 transmits a file addition completion notification to the explainer terminal 9.

As described above, the file addition is basically performed by the explainer. This allows the customer to display the added file on the writable window without performing any special operation. In a case in which the customer is also able to add a file, an inconvenience such as displaying different files on the explainer terminal and the store terminal and misunderstanding or miscommunication between the customer and the explainer may occur. According to the present embodiment, such a case, or an inconvenience, may be prevented.

A description is given below of processing of switching pages performed by the explainer or the customer.

S28: The explainer performs an operation to specify a page to be displayed on the writable window. The reception unit 92 of the explainer terminal 9 accepts the specifying operation.

S29: The file display unit 98 of the explainer terminal 9 displays the specified page on the writable window.

S30: The data exchange unit 91 of the explainer terminal 9 specifies a page number of the page replaced by the witching, and transmits a page switch request (page number), or a page switch notification (page number), to the store terminal 1. After that, the explainer terminal 9 waits until the store terminal 1 switches the pages. This is because explanation of the explainer may be unclear unless the explainer teitninal 9 and the store terminal 1 display the same page.

S31: The data exchange unit 11 of the store terminal 1 receives the page switch request, and the file display unit 18 displays the specified page on the writable window.

S32: The data exchange unit 11 of the store terminal 1 transmits a page switch completion notification to the explainer terminal 9.

As described above, the page switching is performed by the explainer. This allows the customer to switch the pages without performing any special operation. In a case in which the customer is also able to switch the pages, an inconvenience such as displaying different pages on the explainer terminal and the store terminal and misunderstanding or miscommunication between the customer and the explainer may occur. According to the present embodiment, such a case, or an inconvenience, may be prevented.

A description is given below of processing of ending the bidirectional writing performed by the explainer or the customer.

S33: The explainer performs an operation to end the bidirectional writing. The reception unit 92 of the explainer terminal 9 accepts the operation.

S34: The data exchange unit 91 of the explainer terminal 9 transmits an end command (deactivation command) to the store terminal 1.

S35: The explainer terminal 9 terminates, or deactivates, the bidirectional writing function. Due to this, the writable window disappears. Further, the write processing unit 96, the menu display unit 97, and the file display unit 98 are disabled.

S36: The data exchange unit 11 of the store terminal 1 receives the end command. The store terminal 1 terminates, or deactivates, the bidirectional writing function. Due to this, the writable window disappears. Further, the write processing unit 16, the menu display unit 17, and the file display unit 18 are disabled.

Restricting Adding Page, Deleting Page, Switching Pages, and Adding File in Store Terminal:

As described with reference to FIG. 29A and FIG. 29B, the store terminal 1 is not capable of accepting the operations of adding a file and specifying a page. In addition, the store terminal 1 is not capable of accepting the operations of adding a page and deleting a page. As one of the methods for implementing such restrictions, there is a method in which the store terminal 1 hides operation buttons related to these operations.

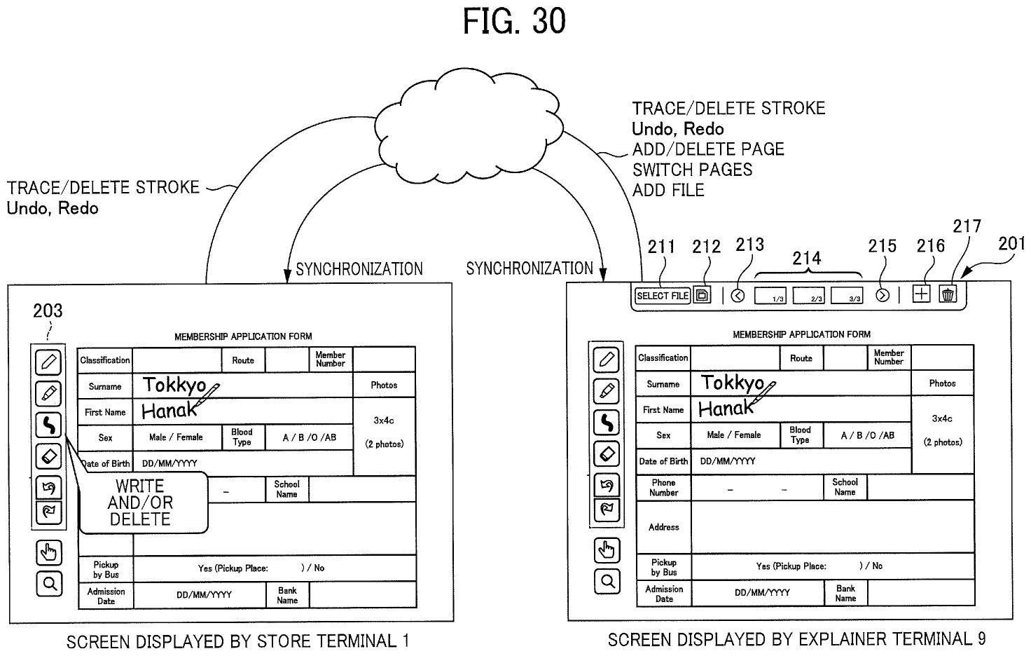

FIG. 30 is a diagram illustrating an example of writable windows displayed by the store terminal 1 and the explainer terminal 9 according to the present embodiment. In FIG. 30, one illustrated at left of the writable windows is the writable window that is displayed by the store terminal 1 and the other one (right side) is the writable window that is displayed by the explainer terminal 9.

Both writable windows display the same document (file), which is “MEMBERSHIP APPLICATION FORM”. Each of the store terminal 1 and the explainer terminal 9 includes a touch panel that allows the customer or the explainer in the store to input the handwritten stroke data with respect to the document (writable window) by using a pen or the like.

As illustrated in FIG. 30, the store terminal 1 does not display the document operation button 201, but the explainer terminal 9 displays the document operation button 201. The document operation button 201 includes a file selection button 211, a save button 212, a page back button 213, thumbnails 214 each of which is for a corresponding page, a page forward button 215, a page add button 216, and a page delete button 217. The file selection button 211 is a button used by the explainer for selecting a file to be added to and displayed on the writable window. Due to this, a file browser is displayed. The save button 212 is a button for saving handwritten strokes and image data in a single file. The page back button 213 is a button for displaying a page that is one page before the page currently displayed on the writable window. Each thumbnail 214 corresponds to a page. In the example of FIG. 30, three thumbnails 214 each of which is corresponding to one of three pages are displayed. The page forward button 215 is a button for displaying a page that is one page ahead of the page currently displayed on the writable window. The page add button 216 is a button for adding a new page in an initial state. The page delete button 217 is a button for deleting the page currently displayed on the writable window.

Accordingly, the store terminal 1 that is not capable of displaying the document operation button 201 is not able to accept the operations of adding a page, deleting a page, switching pages, and adding a file.

Hiding the document operation button 201, as described above, may be performed by the menu display unit 17 of the store terminal 1 based on the service information that indicates, in particular, a role of “STORE”. The service information is stored in the storage unit 1000. The store terminal 1 is not able to display the document operation button 201 no matter what operation the customer performs. (Alternatively, the store terminal 1 may be able to display the document operation button 201 only when receiving a very special operation or input of a password).

The menu display unit 97 of the explainer terminal 9 displays the document operation button 201 based on the service information stored in the storage unit 9000. The menu display unit 97 displays the document operation button 201 when the service information indicates a role of “EXPLAINER” and there is the explainer authority 9004. In the present embodiment in which the explainer may assign the explainer authority, even if the role is “EXPLAINER”, the menu display unit 97 does not display the document operation button 201 unless there is the explainer authority 9004.

As a method of restricting such page operations, there is also another method in which the reception unit 12 does not accept the operations to the document operation button 201 being displayed, instead of the method in which the store terminal 1 hides the document operation button 201. In such a case, the menu display unit 17 may reduce the brightness of the document operation button 201 to be displayed. Reducing the brightness of the document operation button 201 means making the document operation button 201 less noticeable. The document operation button 201 may be grayed out and displayed. Alternatively, the menu display unit 17 may display the document operation button 201, and when the customer operates with respect to the document operation button 201, a message such as “You are failed to perform this operation” may be output.

In the examples of FIG. 29A, FIG. 29B, and FIG. 30, the store terminal 1 does not display the document operation button 201, and thereby restricting the operations performable by the customer. However, the store terminal 1 may display the document operation button 201, and the communication management apparatus 5 may restrict the operations. In this case, the explainer terminal 9 transmits the settings of the restricted operations, namely, restriction settings, (adding a page, deleting a page, switching pages, adding a file) to the communication management apparatus 5. Then, when each of the restricted operations is transmitted from the store terminal 1, the communication management apparatus 5 compares each operation received with the settings of the restricted operations, and returns the corresponding operation to the store terminal 1.

Processing of Restricting Bidirectional Writing:

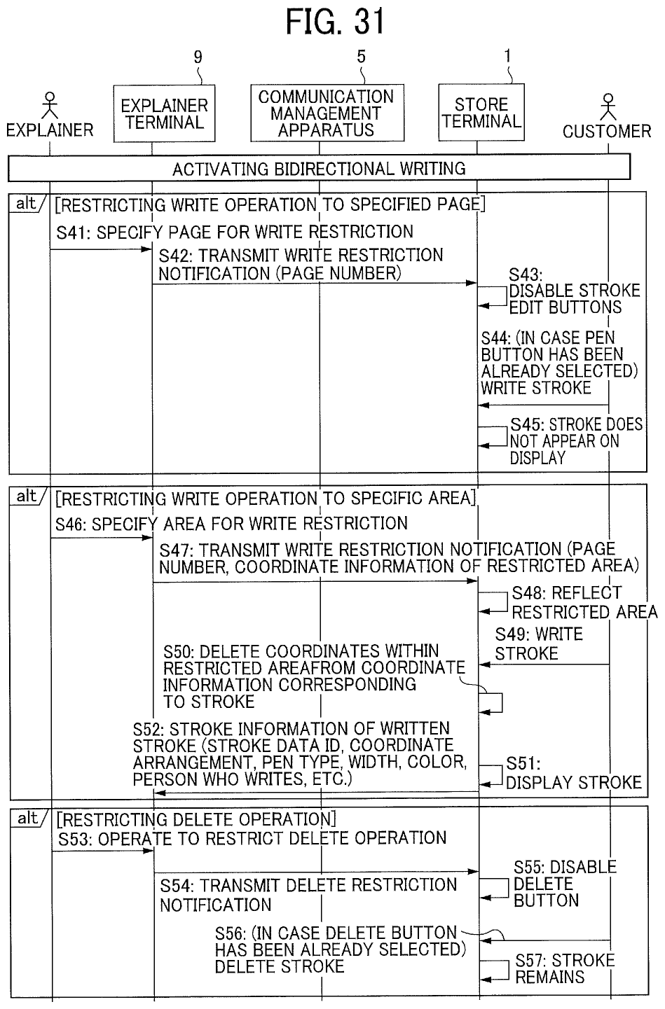

A description is given below of processing of restricting operations of the store terminal 1 related to the bidirectional writing, with reference to FIG. 31. FIG. 31 is a sequence diagram illustrating an example of processing or operation in which the explainer terminal 9 restricts operations performed with the store terminal 1, according to the present embodiment.

First, a description is given of a flow of the processing in which the write operation of the store terminal 1 to a page that is specified by the explainer is restricted.

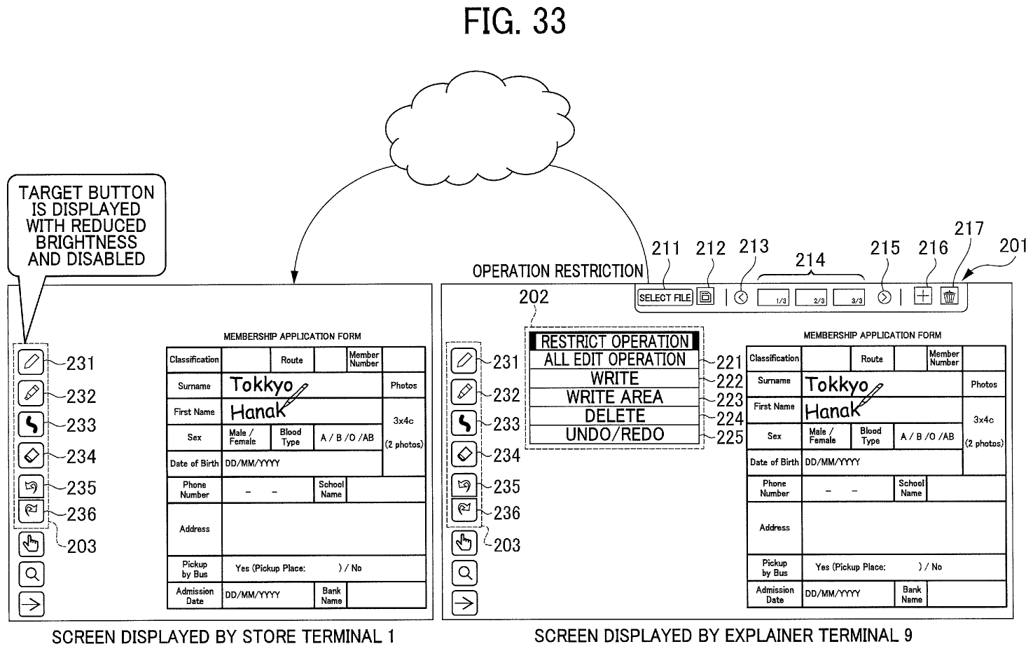

S41: The explainer specifies a page to which the write operation is restricted. The reception unit 92 of the explainer terminal 9 accepts the operation. Simply, the page currently displayed on the writable window is automatically specified. FIG. 33 is a diagram illustrating examples of screens for explaining a write restriction to a page set by using the operation restriction button 202, according to the present embodiment.

S42: The data exchange unit 91 of the explainer terminal 9 specifies a page number and transmits a write restriction notification to the store terminal 1. In general, since the explainer serves customers in a single store, the explainer terminal 9 does not need to specify the store terminal 1 for restricting the write operation. That is, the store terminal 1 is a store teiminal currently communicating with the explainer terminal 9, and the communication management apparatus 5 is capable of uniquely identifying the store terminal 1 by referring to the session management DB. In a case in which there are a plurality of stores where the explainer serves customers, the explainer terminal 9 automatically restricts the write operation to all the corresponding store terminals. Alternatively, in the case in which there are the plurality of stores where the explainer serves customers, the explainer terminal 9 specifies one or more store terminals for which the write operation is restricted. The explainer terminal 9 may specify a communication ID corresponding to each store terminal (the explainer terminal 9 may transmit a communication ID corresponding to each store terminal to the communication management apparatus 5).

S43: The data exchange unit 11 of the store terminal 1 receives the write restriction notification along with the specified page number. The menu display unit 17 of the store terminal 1 disables a pen button 231, a fluorescent button 232, and a marker button 233, of each of which a detailed description is given later, which are included in a stroke edit button 203. For example, the above-mentioned disabled buttons are displayed with reduced brightness, which is, for example, the brightness less than the other buttons or usual (grayed out).

S44: However, there may be a case in which the customer writes a stroke by selecting the stroke edit button 203 (the pen button 231, the fluorescent button 232, or marker button 233), before the menu display unit 17 disables the corresponding buttons included in the stroke edit button 203.

S45: In this case, the write processing unit 16 does not display the corresponding stroke data after receiving the write restriction notification. Further, the write processing unit 16 does not store the stroke data in the stroke data management DB 1003 after receiving the write restriction notification. Since the data exchange unit 11 transmits, to the explainer terminal 9, the stroke data that is stored in the stroke data management DB 1003 by the time when the write restriction notification is received, the stroke data is synchronized.

As described above, the explainer restricts the write operation performed by the customer on a page-by-page basis.

A description is given below of processing in which the explainer specifies a restricted area to which write operations are restricted on the writable window. The write restriction with specifying the restricted area is to restrict the write operation to a part of a page.

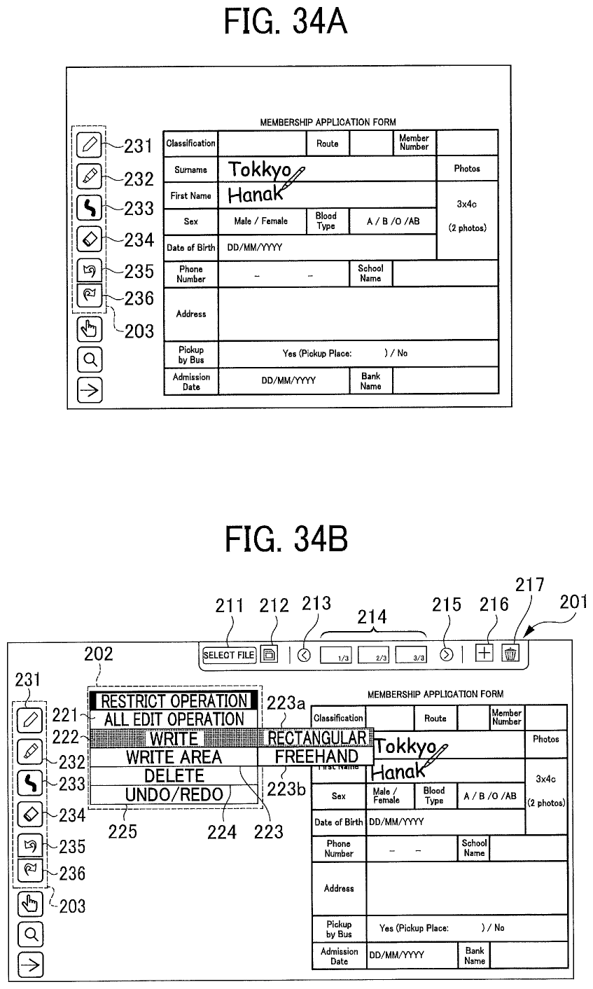

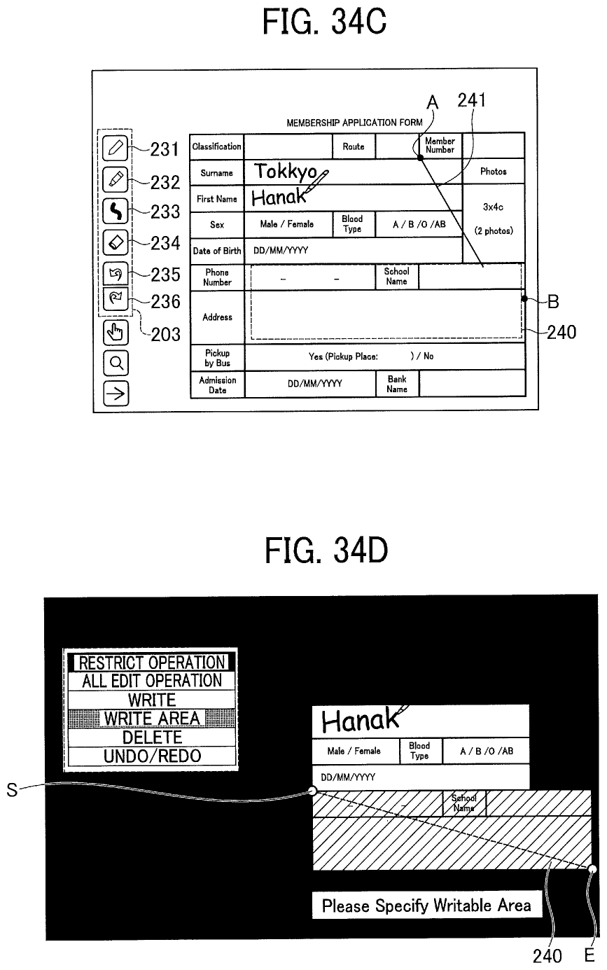

S46: The explainer specifies an area to which the write operation is restricted. In this case, the current page is specified (target) for the write restriction. The reception unit 92 of the explainer terminal 9 accepts the operation. FIG. 34 is a diagram illustrating examples of screens related to the write restriction with a restricted area in the page set by using the operation restriction button 202 according to the present embodiment.

S47: The data exchange unit 91 of the explainer terminal 9 specifies a page number and coordinates of the restricted area and transmits the write restriction notification to the store terminal 1.

S48: The data exchange unit 11 of the store terminal 1 receives the write restriction notification along with the specified page number. The write processing unit 16 of the store terminal 1 starts the write restriction with respect to the restricted area on the currently displayed page. The write restriction means that the write operation of stroke data to the restricted area is not acceptable.

S49: The customer selects one from the buttons included in the stroke edit button 203 (the pen button 231, the fluorescent button 232, or the marker button 233) and writes a stroke. Writing to an area other than the restricted area is acceptable.

S50: The write processing unit 16 deletes the coordinates within the restricted area from the coordinate information corresponding to the stroke data.

S51: The write processing unit 16 displays the received stroke data on the writable window. Accordingly, the stroke data other than the restricted area is displayed. Further, the write processing unit 16 stores the stroke data corresponding to the area other than the restricted area in the stroke data management DB 1003.

S52: The data exchange unit 11 of the store terminal 1 transmits the received stroke data corresponding to the area other than the restricted area to the explainer terminal 9.

As described above, the explainer restricts the write operation performed by the customer on an area-by-area basis in a page.

A description is given below of processing in which the explainer restricts delete operation with respect to stroke data (stroke delete operation) performed by the customer.

S53: The explainer performs an input operation to restrict deletion of stroke data.

The reception unit 92 of the explainer terminal 9 accepts the operation. FIG. 33 is a diagram illustrating examples of screens for explaining a write restriction to a page set by using the operation restriction button 202, according to the present embodiment.

S54: The data exchange unit 91 of the explainer terminal 9 transmits a delete restriction notification to the store terminal 1.

S55: The data exchange unit 11 of the store terminal 1 receives the delete restriction notification. The menu display unit 17 of the store terminal 1 disables a delete button (eraser button 234 of which a detailed description is given later). For example, the above-mentioned disabled button is displayed with reduced brightness, which is, for example, the brightness less than the other buttons or usual (grayed out).

S56 There may be a case in which the customer selects the delete button (eraser button 234) and deletes a stroke before the menu display unit 17 disables the delete button (eraser button 234).

S57: In this case, the write processing unit 16 does not accept the deletion of the stroke data after receiving the delete restriction.

As described above, the explainer restricts the delete operation performed by the customer with respect to the stroke data written on a page.

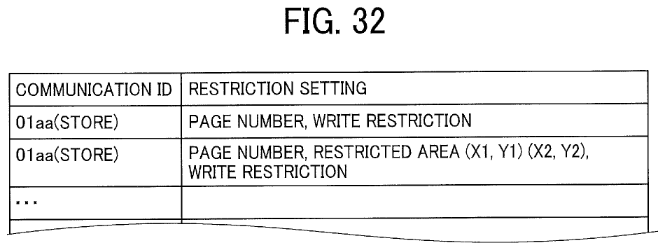

In the example of FIG. 31, the store terminal 1 restricts target operations performed by the customer according to each operation restriction. However, such operation restriction of the customer may be performed by the communication management apparatus 5. In this case, the communication management apparatus 5 manages a restriction setting table as illustrated in FIG. 32.

FIG. 32 is a conceptual diagram illustrating an example of the restriction setting table, according one or more embodiments. In the restriction setting table, restriction settings are registered in association with the communication ID of the store terminal 1 whose operation is restricted. The communication ID is a communication ID of each store and is specified in the session management DB or transmitted from the explainer terminal 9 to the communication management apparatus 5. In the embodiment in which the store terminal 1 does not restrict the operation, since the stroke data and the deletion request are transmitted from the store terminal 1 to the communication management apparatus 5 along with the communication ID, the communication management apparatus 5 restricts each operation, such as a write operation, according to the restriction settings associated with the communication ID of the store terminal 1. The stroke data after the restriction is transmitted to the store terminal 1 and the explainer terminal 9. Accordingly, although being once displayed on the store terminal 1 without any restriction, the stroke is displayed again with the stroke data transmitted from the communication management apparatus 5.

Operation Restrictions on Bidirectional Writing in Store Terminal:

As described with reference to FIG. 31, the store terminal 1 is not capable of accepting each operation of writing stroke data, writing to a restricted area, or deleting stroke data. As one of the methods for enabling such restrictions, there is a method in which the store terminal 1 hides the corresponding operation button according to the restriction settings set by using the explainer terminal 9.

FIG. 33 is a diagram illustrating another example of a writable window displayed by the store terminal 1 and a writable window displayed by the explainer terminal 9 according to the present embodiment. In FIG. 33, one illustrated at left of the writable windows is the writable window that is displayed by the store terminal 1 and the other one is the writable window that is displayed by the explainer terminal 9. In the following description of FIG. 33, differences from FIG. 30 are mainly described.

As illustrated in FIG. 33, the explainer terminal 9 displays the operation restriction button 202, which is a set of sub buttons. The store terminal 1 does not display the operation restriction button 202. The operation restriction button 202 includes sub buttons that are an all edit operation button 221, a write button 222, a write area button 223, a delete button 224, and an Undo/Redo button 225. The all edit operation button 221 is a button that restricts all edit operations including writing of a stroke and deletion of a stroke (all operations performable with the stroke edit button 203) in the store terminal 1. The write button 222 is a button that restricts writing of stroke data on the store terminal 1. The write area button 223 is a button that restricts writing of stroke data to a restricted area on the store terminal 1. The delete button 224 is a button that restricts the deletion of stroke data on the store terminal 1. The Undo/Redo button 225 is a button that restricts “undo/redo” operations for stroke data on a store terminal 1.

The explainer terminal 9 and the store terminal 1 display the stroke edit button 203. The stroke edit button 203 displays the pen button 231, the fluorescent button 232, the marker button 233, the eraser button 234, an undo button 235, and a redo button 236. The pen button 231 is a button that allows the customer to write a stroke in a set color. When the write button 222 is pressed, the pen button 231 is displayed with reduced brightness (grayed out). The fluorescent button 232 is a button that allows the customer to write a stroke of a slightly thick fluorescent color in a set color. When the write button 222 is pressed, the fluorescent button 232 is displayed with the reduced brightness (grayed out). The marker button 233 is a button that allows the customer to write a marker that is temporarily displayed but automatically deleted. When the write button 222 is pressed, the marker button 233 is displayed with the reduced brightness (grayed out). The eraser button 234 is a button that allows the customer to delete a stroke. When the delete button 224 is pressed, the eraser button 234 is displayed with the reduced brightness (grayed out). The undo button 235 is a button that allows the customer to return the stroke data to a state one operation before (undo operation). When the Undo/Redo button 225 is pressed, the undo button 235 is displayed with the reduced brightness (grayed out). The redo button 236 is a button that allows the customer to return the stroke data to a state one operation ahead (redo operation). When the Undo/Redo button 225 is pressed, the redo button 236 is displayed with the reduced brightness (grayed out).

When the all edit operation button 221 is pressed, all sub buttons included in the stroke edit button 203 are displayed with the reduced brightness (grayed out). The operations to the buttons displayed with the reduced brightness are not acceptable. Therefore, the store terminal 1 is not capable of accepting the editing of the stroke data according to the restriction settings set by the explainer.

The menu display unit 97 of the explainer terminal 9 displays the operation restriction button 202 based on the service information stored in the storage unit 9000. The menu display unit 97 displays the operation restriction button 202 when the service information indicates a role of “EXPLAINER” and there is the explainer authority 9004.

The menu display unit 17 of the store terminal 1 does not display the operation restriction button 202 based on the role being “STORE” indicated by the service information stored in the storage unit 1000. The store terminal 1 is not able to display the operation restriction button 202 no matter what operation the customer performs. (Alternatively, the store terminal 1 may be able to display the operation restriction button 202 only when receiving a very special operation or input of a password).

Further, the menu display unit 17 of the store terminal 1 displays each button of the stroke edit button 203 with the reduced brightness according to the restriction settings transmitted from the explainer terminal 9 (according to a button pressed among the buttons included in the operation restriction button 202).

The menu display unit 17 of the store terminal 1 may make the stroke edit button 203 be displayed with reduced brightness, hide the stroke edit button 203, or display a cross mark on the stroke edit button 203. Alternatively, the menu display unit 17 may display the stroke edit button 203, and when the customer operates with respect to the stroke edit button 203, a message such as “You are failed to perform this operation” may be output.

Subsequently, a description is given of a display example of the writable window in a case in which a restricted area to which the stroke data is not written is specified with reference to FIG. 34. FIG. 34A to FIG. 34D are diagrams each illustrating an example of the writable window displayed in a case in which a restricted area to which the writing of the stroke data is not acceptable is specified, according to the present embodiment. FIG. 34A and FIG. 34C are diagrams each illustrating an example of the writable window that is displayed by the store terminal 1. FIG. 34B and FIG. 34D are diagrams each illustrating an example of the writable window that is displayed by the explainer terminal 9. In the following description of FIG. 34A to FIG. 34D, differences from FIG. 33 are mainly described.

FIG. 34A is substantially the same as the writable window displayed by the store terminal 1 illustrated in FIG. 33 In FIG. 34B, the write area button 223 of the operation restriction button 202 is pressed. Accordingly, the write area button 223 displays a rectangular button 223a and a freehand button 223b. Each button specifies a shape of the restricted area. Each button allows the explainer to specify the restricted area for the write operation by using a corresponding one of rectangle or freehand.

FIG. 34D depicts a state in which the explainer has specified the restricted area with a rectangle shape. The shape of the restricted area 240 in FIG. 34D is rectangular. When the explainer drags the pen or the fingertip from a start point S to an end point E, a rectangle having the start point S and the end point E as diagonal vertices is displayed. This rectangle is a restricted area 240 for the write operation.

FIG. 34C depicts an example of a stroke handwritten on the store terminal 1 to which the restricted area for the write operation is notified. The customer handwritten a straight line 241 from a point A to a point B, but a part of the stroke corresponding to the restricted area 240 among the coordinates of the straight line 241 is not displayed. As described above, the explainer restricts the handwriting to the restricted area 240.

Assignment of Explainer Authority to Another Explainer:

In customer service, the explainer may change to support the customer or take over the customer service. For example, an explainer A is in charge of overseas travel and an explainer B is in charge of domestic travel, but the customer may ask about not only the overseas travel but also the domestic travel. A process, in order to deal with such a situation, in which the explainer A assigns the explainer authority 9004 to the explainer B (an example of the second explainer) is described below. The explainer authority is a right to use a tool for an explainer to explain efficiently, and as an example of the authority is a right to restrict the operations performed by the customer in a store.

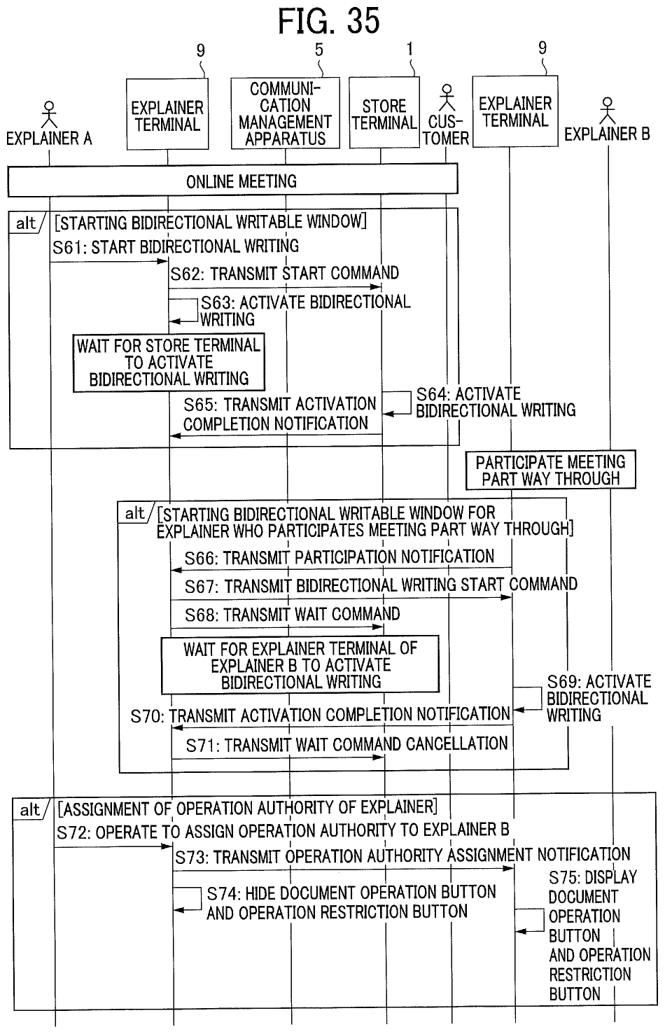

FIG. 35 is a sequence diagram illustrating an example of processing or operation in which the explainer A assigns the explainer authority to the explainer B, according to the present embodiment. A person who assigns the explainer authority 9004 is the explainer A, and another person to who the explainer authority 9004 is to be assigned is the explainer B. For the assignment, there are a case in which the explainer authority 9004 is assigned to the explainer B while the explainer A keeps the explainer authority 9004 after the assignment, and another case in which the explainer authority 9004 is assigned to the explainer B and the explainer A loses the explainer authority 9004 after the assignment. In the example of FIG. 35, the case in which the explainer A loses the explainer authority 9004 after the assignment is illustrated.

S61 to S65: The steeps are substantially the same as the steps S1 to S5 in FIG. 29A.

S66: The explainer B participates in a session being established between the store terminal 1 and the explainer terminal 9, part way through. In other words, there are three bases (sites) for participants in the remote communication. As a method of participating in the meeting part way through, there are a method in which the explainer B selects the explainer A from a destination list, and another method in which the explainer A specifies the session and invites the explainer B. In the present embodiment, any method may be used to participate in the meeting part way through. In the communication management apparatus 5, the communication IDs of the three bases (sites) are associated with each other in the session management DB and the communication information management DB. The explainer terminal 9 (an example of a third communication terminal) of the explainer B specify the own communication ID to be transmitted to the explainer terminal 9 of the explainer A as a notification indicating that the explainer to minal 9 of the explainer B has just participated in the meeting part way through.

S67: The data exchange unit 91 of the explainer terminal 9 of the explainer A receives the notification that indicating that the explainer terminal 9 of the explainer B has just participated in the meeting part way through, and transmits a start (activation) command for the bidirectional writing function to the explainer terminal 9 of the explainer B.

S68: Further, the data exchange unit 91 of the explainer terminal 9 of the explainer A transmits a wait command, which is a command for waiting for the explainer terminal 9 of the explainer B activating the bidirectional writing function, to the store terminal 1. This is because in a case in which the customer writes a stroke before the explainer terminal 9 of the explainer B is activated, the stroke data corresponding to the stroke is failed to be synchronized.

S69 and S70: The steeps are substantially the same as the steps S4 and S5 in FIG. 29A.

S71: The data exchange unit 91 of the explainer terminal 9 of the explainer A receives the activation completion notification and transmits a cancellation of the wait command to the store terminal 1

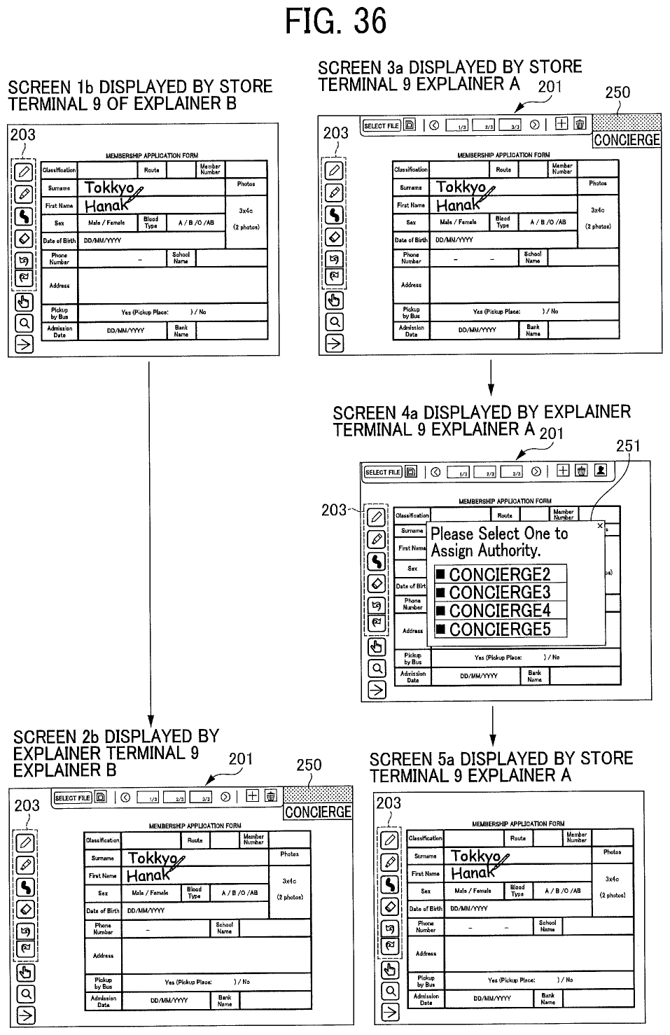

S72: The explainer A performs input operation to assign the explainer authority to the explainer B. The reception unit 92 of the explainer terminal 9 accepts the operation. FIG. 36 is a diagram illustrating an example of screens in assigning the explainer authority, according to the present embodiment.

S73: The data exchange unit 91 of the explainer terminal 9 specifies its own communication ID and transmits an assignment notification with respect to the explainer authority to the explainer terminal 9 of the explainer B.

S74: The menu display unit 97 of the explainer terminal 9 of the explainer A who has lost the explainer authority 9004 hides the document operation button 201 and the operation restriction button 202.

S75: On the other hand, the data exchange unit 91 of the explainer terminal 9 of the explainer B receives the assignment notification with respect to the explainer authority and stores the explainer authority 9004 in the storage unit 9000. As a result, the menu display unit 97 displays the document operation button 201 and the operation restriction button 202.

Display Example of Writable Window in Assignment of Explainer Authority:

FIG. 36 is a diagram illustrating an example of the writable windows each of which is displayed by the explainer terminal 9 used by the explainer A or the explainer B, according to the present embodiment. In FIG. 36, example screens (screen 1b and screen 2b) of the writable window at the left side are the writable windows displayed by the explainer terminal 9 of the Explainer B, and the other example screens (screen 3a, screen 4a and screen 5a) of the writable window at the right side are the writable windows displayed by the explainer terminal 9 of the Explainer A. In the following description of FIG. 36, differences from FIG. 33 are mainly described.

The screen 1b illustrated in FIG. 36, which is displayed by the explainer terminal 9 of the explainer B is substantially the same as the writable window displayed by the store terminal 1 illustrated in FIG. 33 In the screen 3a illustrated in FIG. 36, an authority assign button is displayed. The reception unit 92 of the explainer terminal 9 accepts an operation performed with respect to the authority assign button 250, and the menu display unit 97 displays an explainer list (concierge list) 251 (see screen 4a).

The screen 4a illustrated in FIG. 36 is an example of the writable window displaying the explainer list 251. The explainer list 251 is a list of explainers participating in the same communication. In order to display the explainer list 251, the communication management apparatus 5 acquires the communication IDs of the communication terminals that communicate with each other from the communication information management table illustrated in FIG. 9C. Then, the communication management apparatus 5 identifies each communication ID that has the role of “EXPLAINER” by referring the terminal management table illustrated in FIG. 12A and transmits each communication ID to the explainer terminal 9.

Since the communication IDs participating in the same communication are informed to the explainer terminal 9, each communication ID having the role of “EXPLAINER” may be identified among the communication IDs.

When the explainer A selects, from the explainer list 251, another explainer to whom the explainer A assigns the explainer authority, the reception unit 92 of the explainer terminal 9 accepts the operation. The explainer terminal 9 of the explainer A transmits an assignment notification with respect to the explainer authority 9004 to the explainer terminal 9 of the explainer B.

When the explainer authority 9004 is assigned, the explainer terminal 9 of the explainer B displays the screen 2b, which is the writable window, illustrated in FIG. 36, and the explainer terminal 9 of the explainer A displays the screen 5a, which is the writable window, illustrated in FIG. 36. The explainer terminal 9 of the explainer A does not display the document operation button 201 in the screen 5a, and the explainer terminal 9 of the explainer B displays the document operation button 201 in the screen 2b. Similarly, the explainer terminal 9 of the explainer A does not display the operation restriction button 202, and the explainer terminal 9 of the explainer B displays the operation restriction button 202. The same applies to the authority assign button 250.

In this way, by assigning the explainer authority, the explainer terminal 9 of the explainer B becomes to be capable of displaying the document operation button 201, the operation restriction button 202, and the authority assign button 250.

As described above, the communication system 2 according to the present embodiment is capable of restricting operations of, for example, adding a page, deleting a page, switching pages, adding a file, writing a stroke, deleting a stroke, and editing a stroke, performed by the store terminal 1. This may prevent a trouble such as both the customer and the explainer perform the page switching operations at almost the same time, disturbing the progress of the meeting, for example. This may also prevent a case in which a customer who use the service for the first time so that does not know the operation for switching pages is not able to display a desired page. This may also prevent a case in which a customer fills (inputs) items that are not supposed to be filled by the customer in a restricted area, by especially specifying the restricted area. In addition, the explainer authority of the explainer may be assigned to another explainer.

Variation:

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, the store terminal 1 is an example of a communication terminal. The PC is just one example of the store terminal 1. Other examples of the store terminal 1 includes, but are not limited to, a smartwatch, a game machine, a video call dedicated device.

In the present embodiment described above, improving work efficiency in a customer service of a travel agency is described as an example, however the disclosure may be suitably applied to other industries such as described below. For example, in a financial industry, there are explainers prepared for each skill such as account opening, investment, financing, and mortgage, and in local governments, there are explainers prepared according to a type of service. The disclosure also be applied to hospitals, for example.

Further, in the present embodiment, the communication terminal changes the screen by displaying or hiding a button. In one or more embodiments in which the communication management apparatus 5 distributes the screens, the communication management apparatus 5 may change the screen according to the role of each communication terminal. That is, regarding screen information generated by hypertext markup language (HTML), extensible markup language (XML), Cascade Style Sheet (CSS), JavaScript (registered trademark), etc., the communication management apparatus 5 generates the screen information indicating which of the various buttons is displayed or hidden, and how each button is displayed, for example with the reduced brightness or not.

In addition, the communication management apparatus 5 may have the functions of the relay apparatus 3, or the relay apparatus 3 may have the functions of the communication management apparatus 5. In addition, the functions of the communication management apparatus 5 may be implemented by a plurality of servers, or a plurality of management systems 50 may be used.

In addition, the functional configurations illustrated in FIG. 5 and FIG. 6 are each divided into blocks according to main functions, in order to facilitate understanding the processes performed by the communication management apparatus 5, and the communication terminal. No limitation is intended by how the processes are divided or by the name of the processes. The processes implemented by communication management apparatus 5 and the communication terminal may be divided to a larger number of processes according to the contents of processes. In addition, such division can be such that a single processing unit includes a plurality of processes.

The apparatuses and the like described in the examples are merely an illustration of one of several computing environments for implementing the embodiments disclosed herein. In one embodiment, the communication management apparatus 5 includes a plurality of computing devices such as a server cluster. The multiple computing devices are configured to communicate with one another through any type of communication link including a network, shared memory, etc., and perform the processes described in this disclosure.

Further, the communication management apparatus 5 may be configured to share the disclosed processing steps, for example, FIG. 29A and FIG. 29B, in various combinations. For example, a process executed by a given unit may be executed by a plurality of information processing devices included in the communication management apparatus 5. Further, the communication management apparatus 5 may be integrated into one server device or may be divided into a plurality of devices.

However, in the conventional communication system, each of the first communication terminal and the second communication terminal displays a screen on which the same operations are acceptable. For example, operations such as moving forward a page and switching of materials are performable by using each of the first communication terminal and the second communication terminal. Due to this, a customer who is not familiar with how to use (perform each operation) may perform an unfavorable operation.

In view of the above, an object of the present disclosure is to provide a communication system in which, with respect to the information being displayed on these terminals, the operations acceptable by the first communication terminal are different from the operations acceptable by the second communication terminal.

According to one or more embodiments of the present disclosure, a communication system in which a first communication terminal and a second communication terminal that display the same information communicate with each other, and the first communication terminal displays a screen on which acceptable operations are different from that of the second communication terminal.

According to one or more embodiments of the present disclosure, a communication system in which the first communication terminal displays a screen on which acceptable operations are different from that of the second communication terminal

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A communication system, comprising
a first communication terminal comprising first circuitry configured to display, on a first display, a first screen including information, and
a second communication terminal comprising second circuitry configured to display, on a second display, a second screen including the information, which is same as the first screen,
the first screen and the second screen being different from each other in accepting operations performed with respect to the displayed information.

2. The communication system, according to claim 1,
wherein the first circuitry displays the first screen according to an account type of the first communication terminal.

3. The communication system, according to claim 2,
wherein the first screen includes one or more buttons that are hidden or displayed with reduced brightness.

4. The communication system, according to claim 3,
wherein each of the one or more buttons is for accepting one of the operations performed with respect to the displayed information.

5. The communication system, according to claim 4,
wherein each of the first circuitry and second circuitry displays, as the information, one of one or more pages that are switchable with each other to be displayed,
wherein the operations acceptable with the one or more buttons include adding a page to the one or more pages, deleting one from the one or more pages, switching pages one to another of the one or more pages, and adding a file.

6. The communication system, according to claim 4,
wherein the first screen further includes a stroke edit button, the stroke edit button being configured to accept a stroke edit operation,
wherein, in response to a command to restrict the stroke edit operation, the first circuitry displays the stroke edit button with reduced brightness, the command being generated by a user operation performed using the second communication terminal.

7. The communication system, according to claim 6,
wherein the stroke edit button includes a plurality of buttons, and the stroke edit operation includes a plurality of operations corresponding to the plurality of buttons, each of which is for accepting one of a stroke write operation, a stroke delete operation, an undo operation, and a redo operation, and
wherein, in response to the command to restrict the stroke edit operation, the first circuitry displays one or more of the plurality of buttons with reduced brightness according to restriction settings set in the command, the command being generated by the user operation performed using the second communication terminal.

8. The communication system, according to claim 6,
wherein each of the first circuitry and the second circuitry displays, as the information, one of one or more pages that are switchable with each other to be displayed,
wherein, in response to a command to specify an area as a restricted area in the one of the one or more pages and to restrict a write operation performed to the restricted area on the first screen, the first circuitry restricts the write operation to the restricted area on the first screen, the command being generated by a user operation performed using the second communication terminal.

9. The communication system, according to claim 1,
wherein the second circuitry displays, according to an account type of the second communication terminal, on the second display, the second screen that includes one or more buttons that are not included in the first screen.

10. The communication system, according to claim 9,
wherein the second screen further includes an authority assign button, the authority assign button being configured to accept assigning explainer authority to one of a plurality of different communication terminals placed at a site where the second communication terminal is placed, and
wherein, in response to a user operation performed to the authority assign button, the second circuitry displays, on the second display, a list of the plurality of different communication terminals.

11. The communication system, according to claim 10,
wherein, when one of the plurality of different communication terminals is selected from the list of the plurality of different communication terminals,
the second circuitry
assigns the explainer authority from the second communication terminal to the one of the plurality of different communication terminals, and
displays, on the second display, the second screen with the authority assign button being hidden or displayed with reduced brightness, and
circuitry of the one of the plurality of different communication terminals displays the authority assign button on a display of the one of the plurality of different communication terminals.

12. A communication terminal, comprising
circuitry configured to
communicate with another communication terminal, and
display, on a display, a first screen including information same as being included in a second screen displayed on the another communication terminal, the first screen being different from the second screen in acceptable operations performed with respect to the information.

13. A display method, comprising:
displaying, on a display of a communication terminal, a first screen including information same as being included in a second screen displayed on another display of another communication terminal, the first screen being different from the second screen in acceptable operations performed with respect to the information.
